(19) United States
(12) Patent Application Publication
(10) Pub. No.: US 2004/0256971 A1
(43) Pub. Date: Dec. 23, 2004

(54) Cathode-ray tube, its manufacturing method, color selection mechanism and frame for color selection mechanism

(76) Inventor: Masanaga Tanaka, Kanagawa (JP)

Correspondence Address: RADER FISHMAN & GRAUER PLLC, LION BUILDING, 1233 20TH STREET N.W., SUITE 501, WASHINGTON, DC, 20036, US

(21) Appl. No.: 10/482,064

(22) PCT Filed: Apr. 28, 2003
(86) PCT No.: PCT/JP03/05440

(30) Foreign Application Priority Data
Apr. 30, 2002 (JP) 2002-128732
Dec. 24, 2002 (JP) 2002-372874
Apr. 4, 2003 (JP) 2003-101825

(51) Int. Cl. H01J 29/81; H01J 29/07

(52) U.S. Cl. 313/404; 313/407

(57) ABSTRACT

The present invention provides a color cathode-ray tube, a method for manufacturing thereof, a color selection mechanism, and a flame for the color selection mechanism, in order to improve the temperature drift of the beam landing. According to the present invention, the color selection mechanism having the flame formed of a pair of supporting members and a pair of elasticity providing members in which a color selection mask is provided with tension between the pair of supporting members is provided. Also, as the flame, such as a flame in which the pair of elasticity providing members is made of a flat plate and a surface of the plates is opposed to each other, a flame in which the pair of supporting members with approximately L-shaped cross section is inclined and disposed, or a flame in which both of the elasticity providing members and the supporting members are combined can be employed. The present invention provides the color cathode-ray tube including these color selection mechanism

### FIELD OF THE INVENTION

The present invention relates to a cathode-ray tube and a method for manufacturing thereof, a color selection mechanism, and a flame for the color selection mechanism which are applied to color television sets, computer displays and other display devices, for example.

### BACKGROUND ART

FIG. 39 shows a schematic construction of a conventional color cathode-ray tube. A color cathode-ray tube 1 has a construction in which a cathode-ray tube body 5 is composed of a panel 2 and a funnel 4 having a neck portion 3, a color fluorescent screen 6 is formed on the interior surface of the panel 2 with each fluorescent layer of red, green and blue color, a color selection mechanism 7 is disposed in opposition to the color fluorescent screen 6, and a electronic gun 8 is disposed in the neck portion 3. The color fluorescent screen 6 is formed by arraying, for example, the stripe-shaped fluorescent substance layer of each color. A deflection yoke 9 is provided on the outside of the cathode-ray tube body 5. The color selection mechanism, as shown in FIG. 40, has a pair of supporting members 12, 13, the cross section of which is approximately L-shaped, and a metal flame 16 consisting of a pair of U-shaped elasticity providing members 14 and 15 that are connected at an end of both the supporting members 12, 13; and between the pair of supporting members 12, 13 of the flame 16 a color selection mask 19 is provided with a number of slits (beam aperture) 17 arrayed on a thin metal board in the horizontal direction of the screen and a minute band-shaped what is called grid element 18 formed between the adjacent slits. (refer to Japan patent Laid-open patent application H10-106449.

The U-shaped elasticity providing members 14 and 15 consisting the flame 16 are, for example, made of a square-shaped member, and the both ends thereof are welding to the bottom surface of horizontal portions of the supporting members 12, 13 formed of a horizontal portion and a vertical portion continuing from the horizontal portion having approximately L-shaped cross section. As shown in FIG. 41, when this color selection mechanism 7 is assembled, in the state in which the pair of supporting members 12, 13 are pressurized from the outside and so-called turn-buckle is imposed to deform the flame 16 the color selection mask 19 is welded to the upper surface of each vertical portion of the supporting members 12, 13 having approximately L-shaped cross section, and then, the pressure is released. As a result, the color selection mask 19 is provided on the flame with a predetermined tension. Accordingly, after assembling the color selection mechanism 7, as shown in FIG. 41 with a thick line, color selection mask welded surfaces 12a, 13a of the supporting members 12, 13 of the flame 16 are moved to the fluorescent surface side compared to the state before assembling flame (shown with a fine line).

In this color selection mechanism 7, in case of for example the four point holding, support springs 23 provided with a pin engaging hole 22 at the end thereof are attached to the supporting members 12, 13 and the elasticity providing members 14 and 15 corresponding to the four sides of the flame 16 through respective spring holders 21, such that the color selection mechanism 7 is supported by a panel pin (not shown) which is fixed on the inside surface of the panel 2.

In this cathode-ray tube 1, three electron beams B [BR, BG, BB] corresponding to red(R), green(G) and blue(B) emitted from the electron gun 8 are irradiated on each color fluorescent substance layer of the color fluorescent screen 6 through the slits (beam aperture) 17 of the color selection mechanism 7, then the fluorescent substance layers emit light, and the electron beams BR, BG, BB are scanned by the deflection yoke 9 in the horizontal and vertical directions to display the required color picture.

As a color selection mechanism, other than the above mentioned example, for example, such color selection mechanism as shown in the patent document (Japanese Laid-open patent publication H8-273552) is also known. As shown in FIG. 51, a color selection mechanism 101 is a shadow mask type thereof provided with a flame 106 consisting of a pair of supporting members 102 and 103 opposing to each other and the flat-shaped elasticity providing members 104 and 105 that are joined between ends of the supporting members 102 and 103, and between the supporting members 102 and 103 a color selection mask which is not shown is provided. The elasticity providing members 104 and 105 are joined to the supporting members 102 and 103, such that flat-shaped surfaces 104a, 105a are faced to the fluorescent screen and are curved with elasticity to protrude toward the fluorescent screen side. Numeral 108 denotes a support spring. This color selection mechanism 101 has, as mentioned later, a construction to improve the temperature drift, in which when the color selection mask is expanded by heat, the flame 106 is moved toward the fluorescent screen side to correct the mis-landing of electron beams.

Then, when the cathode-ray tube 1 shown in FIGS. 39 and 40 is operated, the electron beams B [BR, BG, BB] from the electron gun 8 are irradiated on the color fluorescent screen 6 through the slits 17 of the color selection mechanism 7. At this time, the energy of electron beams B that is not able to pass the slits of the color selection mechanism 7 is mainly converted to the heat. The color selection mechanism 7 is expanded by this heat and moved from the position before the temperature going up. Accordingly, the position where the electron beams pass is changed to cause the color defect and color shift.

Further, detailed explanation will be provided. The supporting members 12, 13 constituting the conventional flame 16, as shown in FIG. 44, are joined to the elasticity providing members 14, 15 at one side part (so-called horizontal portion) 11H thereof such that the other side part (so-called horizontal portion) 11V thereof to be attached to the color selection mask 19 made of the thin metal plate is approximately vertically positioned (angle θ is about 90 degrees) with respect to a plane made of the four corners of the color selection mask 19. Here, when the both ends of a beam-shaped body are fixed and strength is imposed on the center of the body, it is going to deform in the direction in which the second momentum of the cross section is minimized. The supporting members 12, 13 have an approximately L-shaped cross section, and when pressurized on the side of the vertical portion 11V thereof in the vertical direction (Y direction) and imposed the turn-buckle, as shown in FIG. 45, the supporting members are deformed in the Y direction and Z direction. When the color selection mechanism 7 is assembled, in order to make the color selection mask 19 have an appropriate tension distribution, as shown in FIGS. 46 and 47, the central portion of the supporting members 12, 13 are greatly deformed compared to both end thereof (see the deformed condition from a position shown by broken lines to that shown by solid lines). Accordingly, when the color selection mechanism 7 is thermally expanded by means of the collision energy of electron beams during the operation of the cathode-ray tube 1, with the reverse movement to that on the assembly in FIG. 41, the distance between the panel and the color selection mechanism, that is, the distance between the fluorescent screen 6 and the color selection mask 19 (so-called grill height) GH is changed, and the position of the beam aperture 17 is changed, the color mis-landing is occurred.

The displacement of the electron beam caused by the temperature rise is called the temperature drift of the beam-landing. Particularly, since the color selection mask 19 of the color selection mechanism 7 is made of a thin metal plate, heat capacity is small, so that the temperature rapidly rises or falls in a short period of time (several minutes) when the current level for the video input to the cathode-ray tube 1 is altered. The expansion of the color selection mask 19 caused by the thermal expansion mainly occurs greatly in the longitudinal direction of the minute band-shaped grid element 18. Thus, a large amount of temperature drift is caused by the thermal expansion and shrinkage of the color selection mask 19 in a short period of time, so that it is difficult to control. Incidentally, the flame 16 is thermally expanded slowly taking several hours.

The phenomenon of the temperature drift will be described in detail.

As described above, in order to give the tension to the color selection mask 19, after the flame 16 of the color selection mechanism 7 is pressurized and deformed at the time of assembling, the color selection mask 19 is welded (see FIG. 41). Therefore, when temperature rises and the thermal expansion of the color selection mask 19 occurs during the operation of the cathode-ray tube 1, the tension of the color selection mask 19 is released to let the flame return to the original form before assembling. At this time, as shown in FIG. 42, the color selection mask 19 is displaced in the direction apart from the fluorescent screen 6, so that the grill height GH is changed (changed by AGH in the direction leaving from the fluorescent screen 6). When the grill height is changed, the position of the slit 17 of the color selection mask 19 is altered, so that the position where the electron beam passing through slit 17 reaches is also changed and the electron beam is not irradiated on the correct position on the fluorescent screen 6. FIG. 43 shows this state. The fluorescent screen 6 is, for example, formed of fluorescent substrate stripes 6R, 6G and 6B of red(R), green (G) and blue (B) with carbon-stripes 6BL formed in between. An electron beam B1 passing through a color selection mechanism 71 before the thermal expansion is irradiated on the green fluorescent substance stripe 6G, for example; however, after the thermal expansion, the grill height GH is changed in the direction of increasing by ΔGH (GH+ΔGH), so that an electron beam B2 passing through a color selection mechanism 72 after the thermal expansion is irradiated on the different color, the blue fluorescent substance stripe 6B, for example and the mis-landing occurs.

Next, comparing the color selection mechanism employing an aperture-grill method of FIG. 40 and the color selection mechanism employing a shadow-mask (slot-mask) method, the temperature drift will be explained.

FIGS. 49A through 49C relate to a conventional color selection mechanism employing the aperture-grill method. FIG. 49A shows the increase of the thermal expansion of the color selection mask 19 by electron beams. The thick lines show before the thermal expansion, and the thin lines show after the thermal expansion. Numeral 20 denotes a path where the flame 16 and the color selection mask 19 are welded. The color selection mask 19 can be freely expanded and shrunk in the direction of a, in which the flame 16 gives tension to the color selection mask 19, so that the color selection mask 19 will expands, when heat is applied. On the other hand, the color selection mask 19 does not expand in the welding path direction of b, in which the color selection mask 19 is welded to the flame 16, so that the color selection mask 19 does not macroscopically expand in accordance with flame 16, when heat is applied to the color selection mask 19. However, microscopically the piece by piece of the grid element 18 expands.

FIG. 49B is a side view showing the flame 16 before and after thermal expansion, viewing from the direction of an arrow B in FIG. 49A. Tension of the elasticity providing members 14, 15 of the flame 16 is released by the thermal expansion, the supporting members 12, 13 are moved to the right and left direction, and as a result, the position of the color selection mask 19 shifts from the position before the thermal expansion to the right hand side as shown in FIG. 49B (namely, departing from the fluorescent screen), and then the grill height GH is changed. However, when seen from the direction of arrow B, the slit is the part where the electron beam passes through, and the displacement of the electron beam does not occur. Namely, the shift of color does not occur.

FIG. 49C is, similar to FIG. 49B, a side view showing the relationship between the electron beam and the color selection mask regarding before and after thermal expansion by viewing from the direction of arrow C. The position of the electron beam B2 passing through a color selection mask 192, when the grill height is changed by AGH, is shifted from the position of the electron beam B1 passing through the color selection mask 19, before thermal expansion, and shift of color occurs.

FIGS. 50A through 50C relate to the color selection mechanism 7′ employing the shadow-mask (slot mask) method. Hereupon, in the above figures, the same symbol with dash added is given to parts corresponding to those in FIGS. 49A through 49C. Similarly to FIG. 49A, FIG. 50A shows the expansion of the color selection mask 19′, when the thermal expansion is caused by the electron beam, and thick lines show before thermal expansion and fine lines show after thermal expansion. Similarly to the aperture-grill method, the expansion of the color selection mask 19′ mainly occurs in the direction of a, where the color selection mask 19′ is provided with tension, and the expansion does not macroscopically occur in the welding path direction of b, in which the color selection mask is welded to the flame 16′ and stays therewith. Thus, after thermal expansion, the electron beam B2 is shifted only in the above direction a having tension, and is not shifted in the welding path direction b. (see FIG. 50A).

FIG. 50B is a side view showing the frame 16′ before and after thermal expansion, viewing FIG. 50A from the arrow. B direction. Similarly to FIG. 49B, the flame 16′ is released by the thermal expansion and deforms in the direction of the grill height GH. At this time, by both the causes of shifting the position of the beam aperture 17′ of the color selection mask 19′ in the direction a having a tension and changing the flame 16′ in the direction of the grill height GH, the position where the electron beam reaches the fluorescent screen is shifted. As mentioned above, in the color selection mechanism 7′ employing the shadow mask (slot mask) method, since the part where the electron beam passes through is an aperture, on the thermal expansion of the color selection mask 19′ by the electron beam, not only the change of the grill height GH but also the shift of the electron beam in the tensioned direction of the color selection mask 19′ occur. FIG. 50C shows the relationship between the electron beams B1, B2 and the color selection masks 191′, 192′ before and after thermal expansion, viewing FIG. 50A from arrow C direction. By the change of the grill height GH, the position of the electron beam also changes in this direction.

As mentioned above, for example, in the color selection mechanism 7 of the aperture grill method, the amount of the change of grill height GH is different between the center part and both ends of the supporting members 12, 13, so that when either of the GH is prevented from changing, the other may change. Conventionally, both ends where the shift of color is most frequently observed have particularly been controlled, and the other part on the screen could be allowed, if it is within the acceptable value. However, frequently support spring 23 and spring holder 21 are attached to the center of the supporting members 12, 13. On the thermal expansion of the color selection mask 19, when the grill height GH at the both ends is prevent from being changed, the grill height GH of the center of the supporting members 12, 13 are changed an d excessive stress is given to the support spring 23. Specifically, as shown in FIG. 48, the stress to be bended in the width direction of the plate occurs at the support spring 23. As a result, various characteristics of the cathode-ray tube are dispersed, the flame 16 is deformed, and it is a cause of the shift of color. Conventionally, without taking drastic measures for these phenomena, the result was within the acceptable value and it is approved as a product. However, lately, the more accurate and high-definition cathode-ray tube is required to be produced stably, and the above mentioned problems are required to be solved.

In prior art of the above mentioned FIG. 51, as the measures against the temperature drift, for example, at the time of the thermal expansion, the color selection mechanism is moved to the side of the fluorescent screen by the amount of the change ΔGH of the grill height GH, so that the path of the electron beam is corrected, and at the time of the thermal expansion the color selection mask is able to move to the side of the fluorescent screen in order to correct the shift of both the grill height GH and the slot position at same time, with forming the elasticity providing members 104, 105 in bow-shape.

However, lately, large-sized and hi-definition color television sets have been in practical use, and thus it is required that the temperature drift is further minimized.

### DISCLOSURE OF THE INVENTION

The present invention provides a cathode-ray tube in which the amount of temperature drift of the beam-landing is further minimized, a method for manufacturing thereof, a color selection mechanism for use in the cathode-ray tube and the flame for the color selection mechanism.

The first aspect of the present invention is a color selection mechanism formed with a flame consisting of a pair of supporting members and a pair of elasticity providing members and a color selection mask provided on the flame with tension, in which on the thermal expansion of the color selection mask the supporting members are not displaced mainly in the direction of the axis of the tube.

According to the first aspect of the present invention, even if the color selection mask is expanded by heat, the supporting members of the flame is not easily displaced, so that the amount of change of the grill height becomes close to zero as small as possible and the temperature drift of the beam landing can be reduced to the minimum.

The first aspect of the present invention will be described in detail.

The color selection mechanism according to the first aspect of the present invention includes the flame composed of the pair of supporting members and the pair of elasticity providing members, in which the color selection mask is provided with tension between the pair of supporting members, and on the thermal expansion of the color selection mask, the supporting members are not displaced mainly in the direction of the axis of the tube.

Further, the color selection mechanism according to the first aspect of the present invention includes the flame composed of the pair of supporting members and the pair of elasticity providing members, in which the color selection mask is provided with tension between the pair of supporting members, and the elasticity providing members are formed of a member that is elastically deformed in a surface which intersects a surface including a normal at the center of the color selection mask.

In this color selection mechanism, the elasticity providing members can be attached to the supporting members such that the angle θ formed by the surface in which the elasticity providing members are elastically deformed and a normal of the center of the color selection mask satisfies 0°<θ<90°. Preferably, in order to secure the strength of the elasticity providing members, the elasticity providing member is attached to the supporting members such that the angle θ satisfies 0°<θ<60°. Further preferably, in order not to disturb the incidence of beams, the elasticity providing member is attached to the supporting members such that the angle θ satisfies 0°<θ<45°. Furthermore preferably, in order to control the change in the grill height GH direction, the elasticity providing members are attached to the supporting members such that the angle θ satisfies 10°<θ<45°.

Further, the color selection mechanism according to the first aspect of the present invention includes the flame composed of the pair of supporting members and the pair of elasticity providing members, in which the pair of elasticity providing members are made of flat plates and provided such that surfaces thereof are opposite to each other.

The pair of elasticity providing members can be formed of flat plates with a stepped portion in the thickness direction. This stepped portion is desired to be set symmetrically at each of the pair of elasticity providing members. This stepped portion provided at the pair of elasticity providing members is formed of a bent portion projecting on the side where the elasticity providing members oppose each other and/or on the opposite side of flat surface portion of the elasticity providing members, while the closest portion to the end on the flat portion is set to the standard position.

In this color selection mechanism, the elasticity providing members can be attached to the supporting-members such that the surface of the flat plate is parallel to the normal of the center of the color selection mask.

As described above, the elasticity providing members can be attached to the supporting members such that the angle θ between the surface of the flat plate and the normal of the center of the color selection mask satisfies 0°<θ<90°. Preferably, the elasticity providing members are attached to the supporting members such that the angle θ satisfies 0°<0<60°. Further preferably, the elasticity providing members are attached to the supporting members such that the angle θ satisfies 0°<θ<45°. Furthermore preferably, the elasticity providing member is attached to the supporting members such that the angle θ satisfies 10°<θ<45°.

The connection between the pair of supporting members and the pair of elasticity providing members formed of flat plates and provided with respective surfaces thereof opposing each other is performed such that the supporting members are formed each having approximately L-shaped cross section, consisting of a vertical portion welded to the color selection mask and a horizontal portion continued from the vertical portion; an engaging groove provided on the elasticity providing member is engaged with the horizontal portion having approximately L-shaped cross section; and the horizontal portion and vertical portion of the supporting members having approximately L-shaped cross section are welded to the elasticity providing members.

In the color selection mechanism having the elasticity providing members made of a flat plate and inclined to intersect the normal of the center of the color selection mask, supporting means for the panel is attached to the part of, the elasticity providing members where the change of distance between the fluorescent screen and color selection mask at time of the thermal expansion of the color selection mask is minimized including the case of which is zero, in other words, attached to the part where the change is as small as possible.

A cathode-ray tube according to the first aspect of the present invention includes the first color selection mechanism as mentioned above.

According to the cathode-ray tube of the present invention, since the color selection mechanism in which on the thermal expansion of the color selection mask, the supporting members of the flame are not displaced mainly in the direction of the axis of the tube is included, the amount of change of the grill height GH based upon the thermal expansion at the operation is reduced as small as possible to zero, and the characteristic of the temperature drift can be improved.

According to the cathode-ray tube of the present invention, since the color selection mechanism in which the elasticity providing members constituting the flame is formed of a member that is elastically deformed in the surface intersecting the surface including a central normal of the color selection mask is included, the amount of change of the grill height GH based upon the thermal expansion at the operation is reduced as small as possible to zero, and the characteristic of the temperature drift can be improved. When the elasticity providing members are attached with an inclination to the supporting members such that a necessary angle θ formed between surface in which the elasticity providing members are elastically deformed and the normal of the center of the color selection mask is obtained, the position where the amount of deformation of the elasticity providing member is zero can be selected on the flame of the color selection mask after providing tension. To the position of the elasticity providing member where the amount of deformation becomes zero the support means is attached, whereby the change of the grill height is suppressed to zero even if the color selection mask is expanded by heat on the operation, and the characteristic of the temperature drift can further be improved.

According to the cathode-ray tube of the present invention, since the color selection mechanism in which the pair of elasticity providing members constituting the flame are formed of a flat plate that and provided opposing each other, even if the color selection mask is expanded by heat and the tension of the elasticity providing member is released on the operation, the displacement of the supporting members toward the fluorescent screen side can be suppressed, and the change of the grill height GH based upon the thermal expansion of the color selection mask is reduced as small as possible to zero, so that the characteristic of the temperature drift can be improved.

Since the flat-shaped elasticity providing members are provided in the vicinity of the color selection mask, the effect of providing a magnetic shield is obtained, and the characteristic of the geomagnetic drift can be improved. With the improvement of the characteristic of the temperature drift and the characteristic of the geomagnetic drift, there is a possibility that the magnetic correction circuit of the beam landing is not required.

Since a flat plate is used for the elasticity providing members, the color selection mechanism can be made with the low cost. When the supporting means for the panel are attached to the elasticity providing members, the characteristics with respect to the welding is improved compared with welding to a conventional flame, and welding can be stabilized with the small electric current. Consequently, there are advantages that it is possible to save the electric power at the time of the production of the color selection mask and also life of the electrode of the welding becomes longer. The temperature when the color selection mask is produced can be controlled without difficulties.

When the pair of elasticity providing members have the stepped portion in the thickness direction of the plate, on providing the color selection mask with tension at the time of manufacturing the color selection mechanism, the elasticity providing members deform easily in the thickness direction of the plate and may not easily deform in the width direction of the plate, so that the flame is not easily deformed in the grill height direction. Therefore, the change of the grill height is further reduced close to zero, and further improvement of the characteristics of the temperature drift can be obtained. When the stepped portions are each provided asymmetrically at the pair of elasticity providing members, the pair of elasticity providing members can be elastically deformed with uniformity.

When the elasticity providing members are welded to the supporting members with inclination, there is obtained the position where the amount of deformation of the elasticity providing member is zero with respect to the grill-height direction. Therefore, by attaching the supporting means for the panel to the position where the amount of deformation is zero, the change of the grill height can be suppressed to zero, even if the color selection mask is expanded by heat on the operation, and the temperature drift can further be minimized and then the characteristic of the temperature drift is further improved.

The supporting members have approximately L-shaped cross section, formed of the vertical portion joined to the color selection mask and the horizontal portion continued from the vertical portion, the engaging groove provided on the elasticity providing member is engaged with the horizontal portion, and then the color selection mechanism is constructed by welding the supporting members with the L-shaped cross section formed of the horizontal portion and vertical portion to the elasticity providing portion, so that the color selection mechanism having the strong junction between the supporting members and the elasticity providing members can be obtained without difficulties.

According to the first color selection mechanism of the present invention, since the displacement of the supporting members in the grill height direction can be suppressed when the color selection mask is expanded by heat, the characteristic of the temperature drift can be improved when the color selection mechanism is applied to the cathode-ray tube. Moreover, the effectiveness similar to that of the above mentioned color selection mechanism is obtained.

The second aspect of the present invention is the color selection mechanism in which the color selection mask is provided on the flame composed of the supporting members having approximately L-shaped cross section inclined in the direction of reducing the change of grill height and joined to the pair of elasticity providing members.

According to the second aspect of the present invention, since the supporting members constituting the flame is inclined in the direction of reducing the change of grill height, that is, provided in a dogleg shape to be joined with the elasticity providing members, the flame is deformed by pressure only in the direction of provided pressure at the time when the color selection mask is provided with tension, as described above. So that, when the color selection mask is expanded, the supporting members are only changed to the, opposite side of the pressurized direction, the change of the grill height is controlled.

The second aspect of the present invention will be explained in detail.

The color selection mechanism according to the second aspect of the present invention is composed of the pair of supporting members and the pair of elasticity providing members, and the color selection mask is provided with tension on the flame in which the supporting members having approximately L-shaped cross section are inclined in the direction of reducing the change of grill height and are joined to the elasticity providing members.

In this color selection mechanism, of two side portions constituting approximately L-shaped cross section of the supporting member at the flame, an angle γ between the tangent line of the side portion where the color selection mask is attached and the surface of the color selection mask can be set to 0°<γ<90°. Hereupon, when the length of the two side portions constituting approximately L-shaped cross section of the supporting member at the flame is equal, the angle γ is preferably set to 20°≦γ≦45°. Also, of the two side portions constituting approximately L-shaped cross section of the supporting member at the flame, when the length of one side portion where the color selection mask is attached is L1 and the other side portion is L2 and the relation is set to L1<L2, it is preferable to set the angle γ smaller than that when set to L1=L2. Also, of the two side portions constituting approximately L-shaped cross section of the supporting member at the flame, when the length of one side portion where the color selection mask is attached is L1, and the other side portion is L2, and the relation is set to L1>L2, it is preferable to set the angle γ larger than that when set to L1=L2.

In this color selection mechanism, of the two side portions constituting approximately L-shaped cross section of the supporting member at the flame, the end of the side portion where the color selection mask is not attached can be constructed without chamfering.

The flame for the color selection mechanism according to the present invention is, as mentioned above, formed of the pair of supporting members and the pair of elasticity providing members, and the above supporting members having approximately L-shaped cross section is inclined in the direction of reducing the change of grill height and joined to the elasticity providing members. Then, of the two side portions constituting approximately L-shaped cross section of the supporting members, an angle γ between the tangent line of the side surface of one side portion where the color selection mask is attached and the surface of the mask can be set to 0°<γ<90°. As mentioned above, in accordance with the length of the two side portions the angle γ is preferably set.

The cathode-ray tube according to the second aspect of the present invention includes the above described second color selection mechanism.

According to the cathode-ray tube of the present invention, since the above color selection mechanism is included, when the color selection mask is expanded at the time of the operation the change of grill height can be suppressed and the shift of color does not easily occur.

According to the cathode-ray tube of the present invention, since the color selection mechanism is included in which the supporting members having approximately L-shaped cross section constituting the flame are inclined in the direction of reducing the change of grill height and joined to the pair of elasticity providing members, the color selection mask is not easily changed in the grill height direction, when it is affected by heat on the operation, so that the shift of the color can be suppressed. Therefore, the characteristic of the temperature drift can be improved.

With the color selection mechanism, when an angle γ between the tangent line of the surface of the supporting members with the approximately L-shaped cross section where the color selection mask is attached and the tangent line of the side surface is set to 0°<γ<90°, regardless of the length of the two side portions constituting the supporting member, the angle γ with which the change of grill height becomes zero exists without fail. Thus, by selecting that angle γ, the grill height is suppressed at the time of the operation and the characteristic of the temperature drift can be improved. By setting the angle γ to the optimum value in accordance with the length of the two side portions constituting approximately L-shaped cross section of the supporting members, even if the thermal affection is given, the change in the grill height direction can be suppressed reliably and the characteristic of the temperature drift can be improved.

With this color selection mechanism, of the two side portions constituting approximately L-shaped cross section of the supporting member, the end portion of the side portion where the color selection mask is not attached is not necessarily chamfered, because the reflection and shield of the electron beam do not occur at this end. Thus, since chamfering is not required at this end, the number of processing such as cutting and pressing is reduced, and the color selection mechanism and further the cathode-ray tube will be manufactured without difficulties.

According to the color selection mechanism of the present invention, the flame composed of the supporting member having approximately L-shaped cross section that is inclined in the direction of reducing the change of grill height and is joined to the elasticity providing member is included, the change of grill height can be suppressed if the color selection mask is affected and expanded by heat. Thus, the characteristic of the temperature drift can be improved when applied to the cathode-ray tube.

According to the flame used for the color selection mechanism of the present invention, since the supporting member having approximately L-shaped cross section is inclined in the direction of reducing the change of grill height, that is, disposed in dogleg shape and joined to the elasticity providing member, the supporting member is deformed only in the pressurized direction and is not deformed in the grill height direction, when the flame is pressurized and deformed in order to provide the color selection mask with tension. Thus, the color selection mechanism that is not easily deformed in the grill height direction can be manufactured. The end portion of one side portion where the color selection mask is not attached is not necessarily chamfered, because the reflection and shield of the electron beam do not occur at this end, so that the number of processing such as cutting and pressing is reduced, and the color selection mechanism can be manufactured at lower costs than conventional ones.

The third aspect of the present invention is the color selection mechanism in which the color selection mask is provided with tension on the flame that is made by combining the elasticity providing member of the above first color selection mechanism and the supporting member at the above second color selection mechanism.

The third aspect of the present invention will further be explained in detail.

The cathode-ray tube according to the third aspect of the present invention includes the color selection mechanism in which the flame is formed of the pair of supporting members and the pair of elasticity providing members, the color selection mask is provided with tension between the above pair of supporting members, the elasticity providing members are made of a member which can be elastically deformed within the surface intersecting the surface with the central normal of the color selection mask, and the above-described supporting members having approximately L-shaped cross section are inclined in the direction of reducing the change of grill height and is joined to the above elasticity providing members.

The cathode-ray tube according to this aspect of the present invention includes the color selection mechanism in which the flame is formed of the pair of supporting members and the pair of elasticity providing members, the color selection mask is provided with tension between the above pair of supporting members, the elasticity providing members are made of a flat plate and disposed such that surfaces thereof are opposite to each other, and the supporting members having approximately L-shaped cross section are inclined in the direction of reducing the change of grill height and are joined to the elasticity providing members.

The cathode-ray tube according to this aspect of the present invention includes the color selection mechanism in which an angle θ between the flat plate surface of the above elasticity providing-members and the central normal of the color selection mask is set to 0°<θ<90°, of the two side portions constituting approximately L-shaped cross section of the supporting members, the angle γ between the tangent line of the surface of the portion where the color selection mask is attached and the surface of the color selection mask is set to 0<γ<90°.

In the cathode-ray tube according to this aspect of the present invention, the above pair of elasticity providing members is formed of flat plates having a stepped portion in the thickness direction of the plate.

In the cathode-ray tube according to this aspect of the present invention, the supporting means to the panel is attached to the portion of the above elasticity providing members where the change of distance between the fluorescent screen and the color selection when the color selection mask is expanded by heat is minimized including the case of zero.

The color selection mechanism used for cathode-ray tube according to the third aspect of the present invention is constructed as follows.

Specifically, the color selection mechanism according to this aspect of present invention has the flame formed of the pair of supporting members and the pair of elasticity providing members, the color selection mask is provided with tension between the pair of supporting members, the elasticity providing members are made of a member which can be elastically deformed within the surface intersecting the surface with the central normal of the color selection mask, and the above-described supporting members having approximately L-shaped cross section are inclined in the direction of reducing the change of grill height and is joined to the above elasticity providing members.

The color selection mechanism according to this aspect of the present invention has the flame formed of the pair of supporting members and the pair of elasticity providing members, the color selection mask is provided with tension between the above pair of supporting members, the elasticity providing members are made of a flat plate and disposed such that surfaces thereof are opposite to each other, and the above supporting members having approximately L-shaped cross section are inclined in the direction of reducing the change of grill height and are joined to the elasticity providing members.

The color selection mechanism according to this aspect of the present invention has a construction in which an angle θ between the flat plate surface of the above elasticity providing members and the central normal of the color selection mask is set to 0°<θ<90°, of the two side portions constituting approximately L-shaped cross section of the supporting members, the angle γ between the tangent line of the surface of the portion where the color selection mask is attached and the surface of the color selection mask is set to 0°<γ<90°.

In the cathode-ray tube according to the third aspect of the present invention, the flame constituting the color selection mechanism is formed by combining the supporting members, in so-called dogleg shape and flat plate of the elasticity providing members, so that the change of grill height based upon the thermal expansion of the color selection mask on the operation can further be suppressed and the characteristic of the temperature drift can further be improved.

The color selection mechanism according to the third aspect of the present invention is formed using the flame combining the supporting members in so-called dogleg shape and flat plate of the elasticity providing members, so that when the color selection mask is affected and expanded by heat, the change of grill height can further be suppressed. Thus, when applied to the cathode-ray tube, the shift of color can be suppressed and the characteristic of the temperature drift can furthermore be improved.

The fourth aspect of the present invention is the color selection mechanism in which the characteristic of the temperature drift is improved and the flame structure is improved to be suitable for mass-production.

The fourth aspect of the present invention will be explained in detail.

The cathode-ray tube according to this aspect of the present invention includes the color selection mechanism in which the flame is formed of the pair of supporting members and the pair of elasticity providing members; the color selection mask is provided with tension between the pair of supporting members; the pair of supporting members are formed with approximately L-shaped cross section; the pair of elasticity providing members is made of the flat plate and provided respective surfaces thereof opposing each other; a cutaway portion is provided at the portion of the supporting member where the elasticity providing member is attached to; the surface of the cutaway portion, where the elasticity providing member is brought in contact with, has an angle corresponding to an angle of the elasticity providing members when attached to the supporting members; the plate surface of the elasticity providing member is brought in contact with the surface of the cutaway portion of the supporting members; and supporting members and the elasticity providing members are joined.

The cathode-ray tube according to this aspect of the present invention includes the color selection mechanism in which the flame is formed of the pair of supporting members and the pair of elasticity providing members; the color selection mask is provided with tension between the pair of supporting members; the pair of supporting members are formed with approximately L-shaped cross section; the pair of elasticity providing members is made of the flat plate and provided respective surfaces thereof opposing each other; a cutaway portion is provided at the portion of the elasticity providing member to which the above supporting member is attached; the surface of the cutaway portion, where the supporting member is brought in contact with, has an angle corresponding to an angle of the elasticity providing members when attached to the supporting members; the surface for the contact of the cutaway portion of the elasticity providing member is brought in contact with the surface of the supporting members; and the supporting members and the elasticity providing members are joined.

The cathode-ray tube according to this aspect of the present invention includes the color selection mechanism in which the flame is formed of the pair of supporting members and the pair of elasticity providing members; the color selection mask is provided with tension between the pair of supporting members; the pair of supporting members are formed with approximately L-shaped cross section; the pair of elasticity providing members is made of the flat plate and provided respective surfaces thereof opposing each other; an end surface of the supporting member having approximately L-shaped cross section to which the elasticity providing member is attached has an angle corresponding to an angle at which the elasticity providing member is attached to the supporting member; the plate surface of the elasticity providing member is brought in contact with the whole surface of the end surface of the supporting member; and the supporting members and the elasticity providing members are joined.

The cathode-ray tube according to this aspect of the present invention includes the above mentioned color selection mechanism, so that the amount of temperature drift of the beam landing can be suppressed to minimum. Further, since the mass-production of the color selection mechanism is possible, the cathode-ray tube of this kind can be provided inexpensively.

Specifically, according to the cathode-ray tube of this aspect of the present invention, the elasticity providing members constituting the flame of the color selection mechanism are made of the flat plate, and are disposed with respective surfaces opposing to each other. Accordingly, the supporting members of the flame are not easily deformed in the tube axis direction, when the color selection mask is expanded. Thus, the amount of change of grill height is reduced as small as possible and becomes close to zero, and the temperature drift of the beam landing can be suppressed to minimum.

Further, with respect to the position where the supporting members and the elasticity providing members constituting the flame are joined, the cutaway portion is provided at the portion of the supporting member, to which the elasticity providing member is attached, the surface of the cutaway portion where the elasticity providing member is brought in contact with has an angle corresponding to an angle of the elasticity providing members attached to the supporting members, and when the plate surface of the elasticity providing member is brought in contact with the surface for the contact to join, the cutaway portion with the surface for the contact can be easily manufactured by the press processing without cutting process. Thus, the flame itself, further the color selection mechanism, and consequently the cathode-ray tube can be produced at lower costs and on the mass production basis.

Further, with respect to the position where the supporting members and the elasticity providing members constituting the flame are joined, the cutaway portion is provided at the portion of the elasticity providing member, to which the supporting member is attached, the surface of the cutaway portion where the supporting member is brought in contact with has an angle corresponding to an angle of the elasticity providing members attached to the supporting members, and when the surface for the contact is brought in contact with the supporting member to join, the cutaway portion with the surface for the contact can be easily manufactured by the press processing without cutting process. Thus, the flame itself, further the color selection mechanism, and consequently the cathode-ray tube can be produced at lower costs and on the mass production basis.

Further, with respect to the position where the supporting members and the elasticity providing members constituting the flame are joined, the end surface of the supporting member, to which the elasticity providing member is attached, has an angle corresponding to the angle of the elasticity providing members when attached to the supporting members, and when the plate surface of the elasticity providing member is brought in contact and joined to the whole of the end surface of the supporting members, the portion for the joint on the supporting member side can easily be manufactured with the press processing without a cutting process. Thus, the flame itself, moreover, the color selection mechanism, and consequently, the cathode-ray tube can be produced at lower costs and on the mass production basis.

The fifth aspect of the present invention is the color selection mechanism in which on the flame that is made by combining the elasticity providing members of the flat plate and the dogleg-shaped supporting members described in the first and second aspects of the present invention and the joining means between the elasticity providing members and the supporting member of the fourth aspect of the invention, the color selection mask is provided with tension to further improve the characteristic of the temperature drift and to be suitable for the mass production.

The fifth aspect of the present invention will be explained in detail.

The cathode-ray tube according to this aspect of the present invention includes the color selection mechanism in which the flame is formed of the pair of supporting members and the pair of elasticity providing members; the color selection mask is provided with tension between the pair of supporting members; the pair of elasticity providing members is made of the flat plate and provided respective surfaces thereof opposing each other; the pair of supporting members formed with approximately L-shaped cross section is inclined and disposed in the direction of the change of grill height being reduced; a cutaway portion is provided at the portion of the supporting member to which the elasticity providing member is attached; the surface of the cutaway portion, where the elasticity providing member is brought in contact with, has an angle corresponding to an angle of the elasticity providing members when attached to the supporting members; the plate surface of the elasticity providing member is brought in contact with the surface of the cutaway portion of the supporting members; and supporting members and the elasticity providing members are joined.

The cathode-ray tube according to this aspect of the present invention includes the color selection mechanism in which the flame is formed of the pair of supporting members and the pair of elasticity providing members; the color selection mask is provided with tension-between the pair of supporting members; the pair of elasticity providing members is made of the flat plate and provided respective surfaces thereof opposing each other; the pair of supporting members formed with approximately L-shaped cross section is inclined and disposed in the direction of the change of grill height being reduced; a cutaway portion is provided at the portion of the elasticity providing member to which the supporting member is attached; the surface of the cutaway portion, where the supporting member is brought in contact with, has an angle corresponding to an angle of the elasticity providing members when attached to the supporting members; the surface for the contact of the cutaway portion of the elasticity providing member is brought in contact with the surface of the supporting members; and supporting members and the elasticity providing members are joined.

The cathode-ray tube according to this aspect of the present invention includes the color selection mechanism in which the flame is formed of the pair of supporting members and the pair of elasticity providing members; the color selection mask is provided with tension between the pair of supporting members; the pair of elasticity providing members is made of the flat plate and provided respective surfaces thereof opposing each other; the pair of supporting members formed with approximately L-shaped cross section is inclined and disposed in the direction of the change of grill height being reduced; the end surface of the supporting members having approximately L-shaped cross section, to which the elasticity providing member is attached, has an angle corresponding to the angle of the elasticity providing members when attached to the supporting members, the plate surface of the elasticity providing members is brought in contact with the whole end surface of the supporting members, and the supporting members and the elasticity providing members are joined.

Here, with the color selection mechanism, it is preferable that the angle θ between the surface of the flat plate of the above elasticity providing members and the central normal of the above color selection mask is set to 0°<θ<90°, and of the two side portions constituting the approximately L-shaped cross section of the above supporting members, the angle γ between the tangent line of a side surface of one of the side portions to which the color selection mask is attached and the surface of the selection mask is set to 0°<θ<90°.

According to the cathode-ray tube of this aspect of the present invention, as is clear from the explanation above, the temperature drift is further improved, mass production of the color selection mechanism is possible, and the cathode-ray tube of this kind can be provided inexpensively.

In the color selection mechanism used for each cathode-ray tube as mentioned above, the connection between the supporting members and the elasticity providing members constituting the flame can be performed as the connection between each of the one side portion and the other side portion constituting the supporting members, and the elasticity providing members.

A method for manufacturing the cathode-ray tube according to the present invention is the method for manufacturing the cathode-ray tube including the color selection mechanism which has the flame formed of the pair of supporting members having approximately L-shaped cross section and the pair of elasticity providing members made of the flat plates and in which the color selection mask is provided with tension between the pair of supporting members; and the method comprises the steps of forming the cutaway portion at the position of the supporting members where the above elasticity providing members are attached to and giving the contact surface of the cutaway portion with the elasticity providing member an angle corresponding to the angle of the elasticity providing members when attached to the supporting members, and bringing the surface of the elasticity providing members in contact with the surface for the contact of the cutaway portion of the supporting members to join and forming the flame to manufacture the color selection mechanism.

According to the method for manufacturing the cathode-ray tube of the present invention, the cathode-ray tube which has an excellent characteristic of the temperature drift can be obtained. Furthermore, the connection portion between the supporting members and the elasticity providing members constituting the flame of the color selection mechanism can be formed only by the use of press processing. That is, the cutaway portion having the surface for the contact of the supporting members can be formed by the press processing without difficulties. Thus, the color selection mechanism can be manufactured inexpensively and on the mass production basis, and the cathode-ray tube can be manufactured at lower costs.

A method for manufacturing the cathode-ray tube according to the present invention is the method for manufacturing the cathode-ray tube including the color selection mechanism which has the flame formed of the pair of supporting members having approximately L-shaped cross section and the pair of elasticity providing members made of the flat plates and in which the color selection mask is provided with tension between the pair of supporting members; and the method comprises the steps of forming the cutaway portion at the position of the elasticity providing members where the above supporting members are attached to and giving the contact surface of the cutaway portion with the supporting member an angle corresponding to the angle of the elasticity providing members when attached to the supporting members, and bringing the surface of the elasticity providing members in contact with the surface for the contact of the cutaway portion of the supporting members to join and forming the flame to manufacture the color selection mechanism.

According to the method for manufacturing the cathode-ray tube of the present invention, the cathode-ray tube with the excellent characteristics of the temperature drift can be obtained. Furthermore, the connection portion between the supporting members and the elasticity providing members constituting the flame of the color selection mechanism can be formed only by the press processing. Specifically, the cutaway portion with a surface for the contact of the elasticity providing members can be made only by the press processing without difficulties. Thus, the color selection mechanism can be produced inexpensively and on the mass production basis, and the cathode-ray tube can be manufactured at lower costs.

A method for manufacturing the cathode-ray tube according to the present invention is the method for manufacturing the cathode-ray tube including the color selection mechanism which has the flame formed of the pair of supporting members having approximately L-shaped cross section and the pair of elasticity providing members made of the flat plates and in which the color selection mask is provided with tension between the above pair of supporting members; and the method comprises the steps of giving the end surface, where the elasticity providing member is attached, of the supporting member having approximately L-shaped cross section an angle corresponding to the angle of the elasticity providing members when attached to the supporting members, and bringing the plate surface of the elasticity providing members in contact with the whole of the end surface of the supporting member to join and forming the flame to manufacture the color selection mechanism.

According to the method for manufacturing the cathode-ray tube of the present invention, the cathode-ray tube with the excellent characteristics of the temperature drift can be obtained. Furthermore, the connection portion between the supporting members and the elasticity providing members constituting the flame of the color selection mechanism can be formed only by the press processing. Specifically, the end surface, having an angle of the elasticity providing member being attached to, of the supporting member of approximately L-shaped cross section can be made only by the press processing without difficulties. Thus, the color selection mechanism can be produced inexpensively and on the mass production basis, and the cathode-ray tube can be manufactured at lower costs.

A method for manufacturing the cathode-ray tube according to the present invention is the method for manufacturing the cathode-ray tube including the color selection mechanism which has the flame formed of the pair of supporting members having approximately L-shaped cross section and the pair of elasticity providing members made of the flat plates and in which the color selection mask is provided with tension between the pair of supporting members; and the method comprises the steps of forming an engagement groove on the elasticity providing member to engage with one side portion of the portions constituting the approximately L-shaped cross section of the supporting member, and engaging one side portion of the supporting member with the engagement groove to join the elasticity providing member and the supporting member so that the flame is formed to manufacture the color selection mechanism.

According to the method for manufacturing the cathode-ray tube of the present invention, the cathode-ray tube with the excellent characteristics of the temperature drift can be obtained.

The above-described cathode-ray tube according to each aspect of the present invention is suitable for use in a larger-sized and hi-definition type cathode-ray tube requiring the minimum temperature drift.

### BRIEF DESCRIPTION OF DRAWINGS

FIG. 1 is a constitutional diagram showing an embodiment of the cathode-ray tube according to the present invention;

FIG. 2 is a perspective view showing an embodiment of the color selection mechanism according to the present invention;

FIG. 3A is a plan view showing the shape of the flame constituting the color selection mechanism of FIG. 2 before and after pressurized, FIG. 3B is the side view seeing from an arrow B direction of FIG. 2A from, and FIG. 3C is the side view seeing from an arrow C direction of FIG. 2A;

FIG. 4 is an enlarged side view for use in explaining the FIG. 2;

FIG. 5A is a side view showing the relevant part of the connection portion of the supporting members and the elasticity providing members, and FIG. 5B is a cross-sectional view taken by the line A-A of FIG. 5A;

FIG. 6 is a perspective view showing another embodiment of the color selection mechanism according to the present invention;

FIG. 7 is a plan view showing the shape of the flame of the color selection mechanism of FIG. 6 before and after pressurized;

FIG. 8 is another modified example of the flame of the color selection mechanism according to the present invention;

FIGS. 9A through 9C are further other modified examples of the flame of the color selection mechanism according to the present invention;

FIG. 10 is a perspective view showing another embodiment of the color selection mechanism according to the present invention;

FIG. 11A is a plan view showing the shapes of the flame constituting the color selection mechanism of FIG. 10 before and after pressurized, FIG. 11B is a side view seeing from an arrow B direction of FIG. 11A, and FIG. 11C is a side view seeing from an arrow C direction of FIG. 11A;

FIGS. 12A and 12B are views for use in explaining the design parameter of the color selection mechanism according to the present invention;

FIG. 13 is a constitutional diagram showing another embodiment of the cathode-ray tube according to the present invention;

FIG. 14 is a perspective view of the color selection mechanism applied to the cathode-ray tube of FIG. 13;

FIG. 15 is an exploded perspective view showing the relevant part of the color selection mechanism according to another embodiment of the present invention;

FIG. 16 is a perspective view showing the relevant part of the color selection mechanism of FIG. 15 in the assembled state;

FIG. 17 is a cross-sectional view showing the relevant part of the color selection mechanism of FIG. 15;

FIG. 18A is an exploded upper side view showing the relevant part of the color selection mechanism of FIG. 15, FIG. 18B is an exploded side view showing the relevant part of the color selection mechanism of FIG. 15, and FIG. 18C is a side view showing the relevant part of the color selection mechanism of FIG. 15 in the assembled state;

FIG. 19 is an exploded perspective view showing the relevant part of the color selection mechanism according to another embodiment of the present invention;

FIG. 20 is a perspective view showing the relevant part of the color selection mechanism of FIG. 19 in the assembled state;

FIG. 21 is a cross-sectional view showing the relevant part of the color selection mechanism of FIG. 19;

FIG. 22A is an exploded side view showing the relevant part of the color selection mechanism of FIG. 19 and FIG. 22B is a side view showing the relevant part of the color selection mechanism of FIG. 19 in the assembled state;

FIG. 23 is an exploded side view showing the relevant part of the color selection mechanism according to another embodiment of the present invention;

FIG. 24 is a side view showing the relevant part of the color selection mechanism of FIG. 23;

FIG. 25 is a side view seeing from the side of the elasticity providing members of the FIG. 24;

FIG. 26 is a cross-sectional view showing the relevant part of the connection method of FIG. 5 applied to the flame of the color selection mechanism of the FIG. 10;

FIG. 27 is a perspective view showing another embodiment of the color selection mechanism according to the present invention;

FIG. 28 is a side view showing the relevant part of the color selection mechanism according to the embodiment of FIG. 27;

FIG. 29 is a side view showing an example of the supporting members constituting the color selection mechanism in the FIG. 27;

FIG. 30 is a side view showing another example of the supporting members constituting the color selection mechanism in the FIG. 27;

FIG. 31 is a side view showing another example of the supporting members constituting the color selection mechanism in the FIG. 27;

FIG. 32 is an explanatory view showing the state in which the flame of the color selection mechanism in the FIG. 27 is pressurized and deformed;

FIG. 33 is an explanatory view showing the positional relationship between the supporting members and the pressurizing elements, when the conventional flame of the color selection mechanism is pressurized and deformed;

FIG. 34 is an explanatory view showing the positional relationship between the supporting members and the pressurizing elements, when the flame of the color selection mechanism of FIG. 27 is pressurized and deformed;

FIG. 35 is a perspective view showing the relevant part of a conventional color selection mechanism;

FIG. 36 is a perspective view showing the relevant part of the color selection mechanism of FIG. 27;

FIG. 37 is a constitutional view showing another embodiment of the color selection mechanism according to the present invention;

FIG. 38 is a side view of the relevant part of the color selection mechanism according to the embodiment of FIG. 37;

FIG. 39 is a constitutional view showing an example of a conventional cathode-ray tube;

FIG. 40 is a perspective view showing a conventional color selection mechanism;

FIG. 41 is a side view showing the shapes of the flame of a conventional color selection mechanism before and after assembled;

FIG. 42 is a cross-sectional view of the relevant part of the cathode-ray tube showing the change of grill height before and after the thermal expansion of the color selection mask of a conventional color selection mechanism;

FIG. 43 is an explanatory view for use in explaining the temperature drift of the beam landing;

FIG. 44 is a side view of the relevant part showing the attached angle of the supporting members of a conventional color selection mechanism;

FIG. 45 is an explanatory view showing deformation by pressure of the supporting members of a conventional color selection mechanism;

FIG. 46 is a plan view for explaining the deformation by pressure of the flame of the color selection mechanism;

FIG. 47 is a side view for explaining the deformation by pressure of the flame of the color selection mechanism;

FIG. 48 is an explanatory view showing the deformation of the support spring caused by the change of grill height;

FIG. 49A is a plan view showing the states of the color selection mask before and after thermal expansion in case of a aperture grill, FIG. 49B is a side view of the aperture grill viewed from an arrow B direction of FIG. 49A, FIG. 49C is a view of the aperture grill viewed from an arrow C of FIG. 49A;

FIG. 50A is a plan view showing the states of the color selection mask before and after thermal expansion in case of a shadow mask (slot mask), FIG. 50B is a side view of the shadow mask (slot mask) viewed from an arrow B direction of FIG. 50A, FIG. 50C is a side view of the shadow mask (slot mask) viewed from an arrow C of FIG. 50A; and

FIG. 51 is a perspective view showing another example of a conventional color selection mechanism.

### BEST MODE FOR CARRYING OUT THE INVENTION

Hereinafter, explanation will be given referring to the drawings.

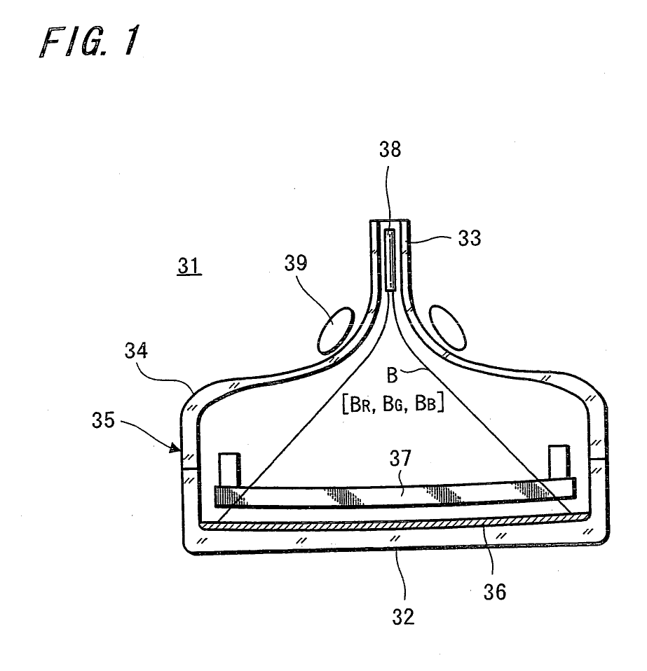

FIG. 1 shows an embodiment of the color cathode-ray tube according to the present invention. The color cathode-ray tube 31 according to the embodiment includes: a cathode-ray tube body 35 which is composed of a panel 32 and funnel portion 34 which has a neck portion 33, a color fluorescent screen 36 which is formed on the interior surface of the panel 32 with red, green and blue fluorescent layers, a color selection mechanism 37 of the present invention, as later described, which is disposed opposing the color fluorescent screen 36, and an electronic gun 38 which is disposed in the neck portion 33. The color fluorescent screen 36 is formed, for example, by arraying stripe-shaped each color fluorescent substance layer. A deflection-yoke 39 is disposed on the outside of the tube body 35.

In this cathode-ray tube 31, three electron beams B [BR, BG, BB] corresponding to red(R), green(G), and blue(B) that are emitted from electron gun 38 are irradiated on the each color fluorescent substance layer of the color fluorescent screen 36 through the color selection mask of the color selection mechanism 37, then the fluorescent substance layers emit light, and the above electron beams BR, BG, BB are scanned by the deflection-yoke 39 in horizontal and vertical directions to display the required color picture.

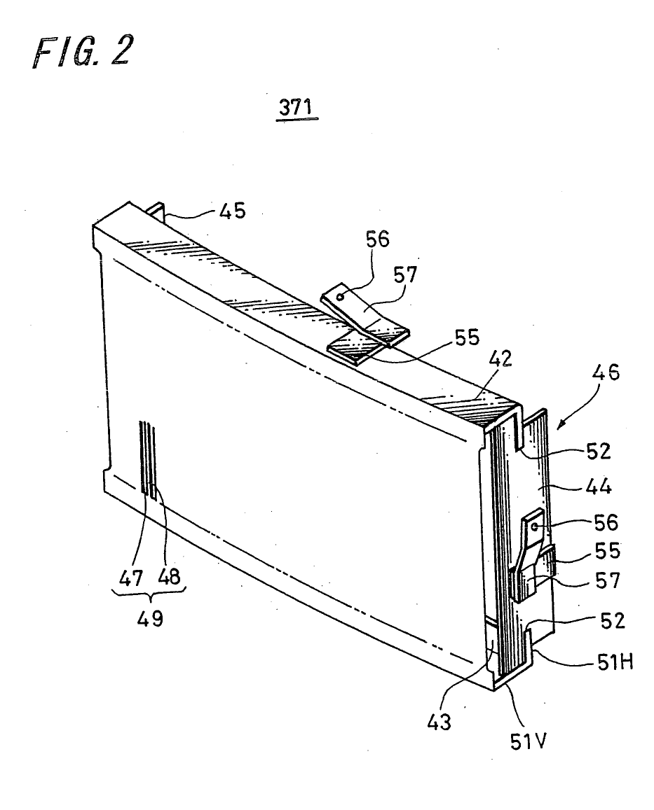

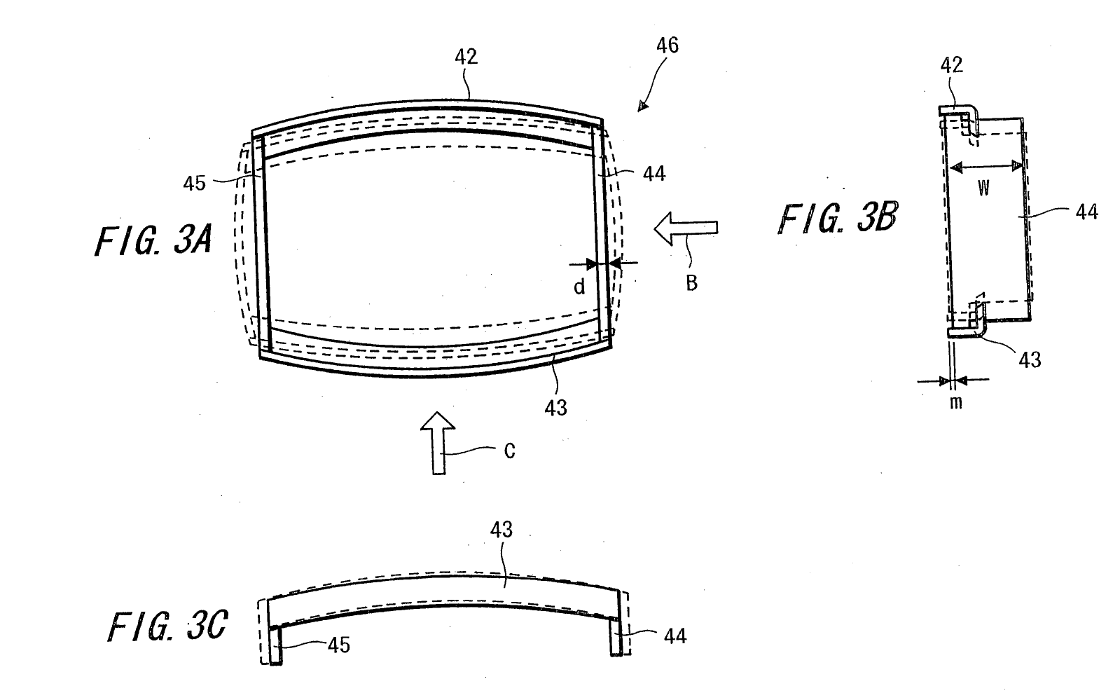

FIGS. 2 and 3 show an embodiment of the color selection mechanism 371 of the present invention. This color selection mechanism 371 has as later described a pair of supporting members 42 and 43 having approximately L-shaped cross section, and a metal flame 46 composed of a pair of elasticity providing members 44 and 45 that are formed by flat plates joined between the both ends of the supporting members 42 and 43 and are provided such that plate surfaces thereof are opposite to each other, in which between the pair of supporting members 42, 43 of the flame 46 a color selection mask 49 is provided with tension with a number of slits (beam apertures) 47 formed on a thin metal board as arranged in the horizontal direction on the screen and minute stripe-shaped so-called grid elements 48 between the adjacent slits 47.

In this embodiment, the elasticity providing members 44 and 45 are attached to the supporting members 42 and 43 such that the surface of the flat plate is parallel to the normal of the center of the color selection mask 49.

The supporting members 42 and 43 has approximately L-shaped cross section formed of one side portion where the color selection mask is welded to, namely a vertical portion 51V and the continuous other portion, namely a horizontal portion 51H. At the both ends of the elasticity providing members 44 and 45, as shown in FIG. 5, an engagement groove 52 where the horizontal portion 51H of the supporting members 42 and 43 having approximately L-shaped cross section is engaged along the plate surface, is formed. Further, in this embodiment, a cutaway portion 54 is formed at a portion of the engagement groove 52 corresponding to the bending portion of the supporting members 42, 43 having approximately L-shaped cross section in order to escape the bending portion.

While each of the elasticity providing members 44 and 45 is in the state in which respective engagement grooves 53 are engaged with the horizontal portion 51H of the supporting members 42 and 43, the boundary portion between the vertical portion 51V of the supporting members 42 and 43 and the end of the elasticity providing members 44 and 45 engaged therewith, the boundary portion between the horizontal portion 51V of the supporting members 42 and 43 and the end of the engagement groove 52 of the elasticity providing members 44 and 45 are welded respectively, (arc welding for example) and the both members 42, 43 and 44, 45 are joined. As a welding area 65, for example, as shown with a broken line of FIG. 5, the vertical portions 51V of the supporting members 42 and 43 are engaged with and welded to the ends of the elasticity providing members 44 and 45 from the upper portion to both side portions in the inverse U shape, the horizontal side 51H of the supporting members 42 and 43 are welded linearly along the horizontal portion 51H and, at least, in diagonal positions to each other (that is, shown by a solid line and/or a broken line) on the inner surface and outer surface opposite side to the inner surface of the color selection mask of the horizontal portion 51H. When only welded to one of the diagonal positions at the horizontal portion 51H, it is preferable that the elasticity providing members 44 and 45 formed of flat plates are inclined and welded to the supporting members 42 and 43 so that the welding operation is made to be easy and the strength of the connection is obtained.

The color selection mask 49 is provided with tension between the upper surface of the supporting members 42 and 43 that are opposite to each other and is fixed by welding on the upper end surface of the vertical portion 51V. On the assembly of the color selection mechanism 371, while the pair of supporting members 42 and 43 are pressurized from the outside as is conventionally assembled and the flame 46 is deformed by imposing the turnbuckle, the color selection mask 49 is welded to the upper surface of each vertical portion 51V of the L-shaped supporting members 42, 43, and then the pressure is released. The pressurization to the supporting members 42, 43 can be performed with, for example, the two points equalization (pressurization at total four points on one side), or the three points equalization (pressurization at total six points on one side).

Here, the flame 46 having the elasticity providing members 44 and 45 formed of flat plates has the structure in which when the turnbuckle is imposed on the flame, the elasticity providing members 44 and 45 are easy to deform in the plate thickness direction t and not easy to deform in the plate width direction w. Accordingly, in the state in which turnbuckle is imposed on the flame 46 at the time of assembling, the elasticity providing members 44 and 45 are deformed with bend within the surface intersecting the normal of the center of the color selection mask, as shown in FIGS. 3A through 3C. At this time, the upper side surface of the vertical portion 51V of the supporting members 42, 43 is hardly displaced in the above normal. At FIGS. 3A and 3B, the solid line shows the shape of the flame before pressurized and the broken line shows the shape of the flame after pressurized.

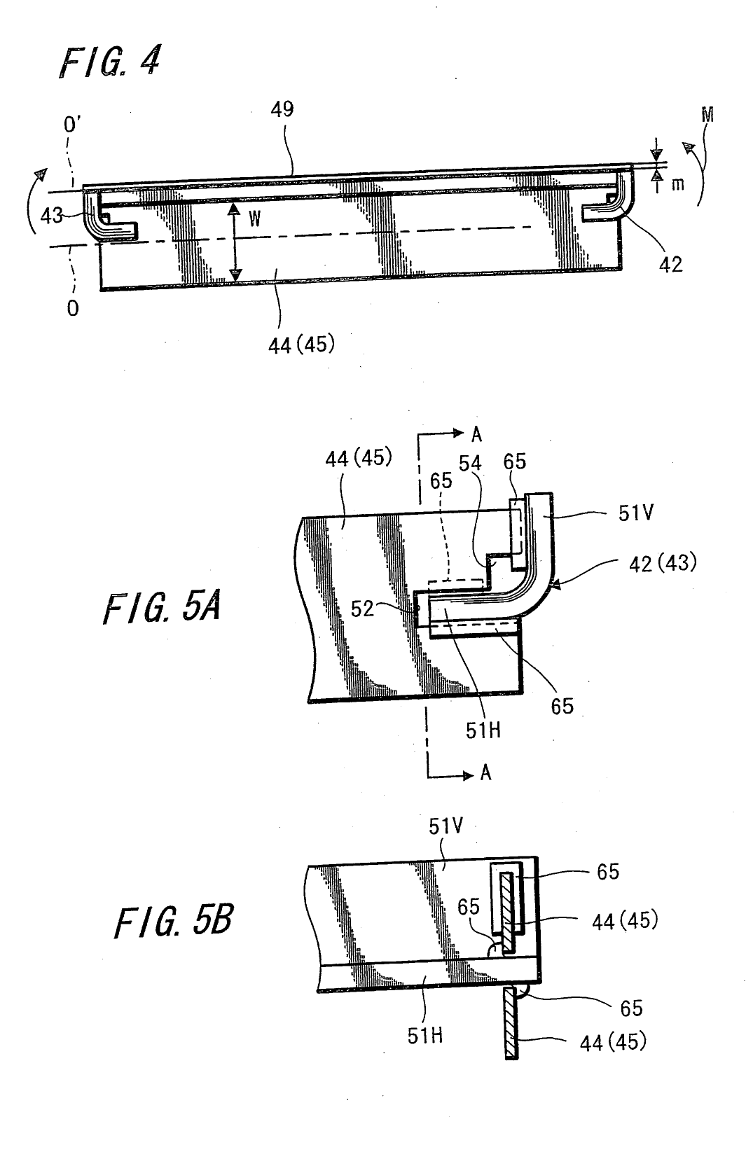

By doing so, the color selection mask 49 is provided with a predetermined tension on the flame. Viewing the state of the color selection mask 49 after provided with tension, as shown in FIG. 4, because the axis of the gravity o (exists at the center of the width direction) of the elasticity providing members 44, 45 and the axis of the gravity o′ of the color selection mask 49 exist at different positions, a moment M toward the color selection mask 49 side works when the color selection mask 49 is provided with tension, and the extremely small amount of flexure deformation occurs in the plate width direction w. However, the flexure deformation m is extremely small compared with that of a conventional color selection mechanism.

In order to support the color selection mechanism 371 by a panel pin (not shown) fixed on the inner surface of the panel 32, when the color selection mechanism is supported by a plurality of points, for example, supported by four points, to the supporting members 42, 43 and the elasticity providing members 44, 45 corresponding to the four sides constituting the flame, supporting means formed of spring holders 55. [551, 552, 553, 554] respectively welded to the four sides and support springs 57 [571, 572, 573, 574] each having a pin engagement hole 56 at the ends welded to respective spring holders 55 are attached. In case supported by tree points, for example, the supporting means are attached to one supporting member 42 and the pair of elasticity providing members 44, 45. On the color selection mask 49, the damper line for preventing the vibration is provided with tension so as to touch the color selection mask.

According to the color cathode-ray tube 31 provided with the color selection mechanism 371 of this embodiment, when the thermal expansion of the color selection mask 49 is caused by the electron beam on the operation, the tension of the elasticity providing members 44 and 45 of the flame 46 is released; however, since the elasticity providing members 44 and 45 are made of flat plates and provided such that the plate surface is parallel to the normal of the center of the color selection mask 49, the supporting members 42 and 43 themselves are hardly displaced in the above mentioned normal direction. Thus, the change of grill height GH before and after the thermal expansion can be reduced as small as possible to zero, and the characteristic of the temperature drift can be improved.

Since the elasticity providing members 44 and 45 are made of flat plates and disposed such that the plate surface is opposite to each other, namely, the elasticity providing members 44 and 45 are provided adjacent to the color selection mask 49, the elasticity providing members 44 and 45 provide the effectiveness of magnetic shield in the vicinity of the color selection mask 49. As a result, the color shift caused by the change of the orbit of electron beams (so called geomagnetic drift) can be made small. This effectiveness can further be increased by appropriately selecting the magnetic characteristics of a material of the elasticity providing members 44 and 45.

There is a possibility of not providing the magnetic compensation circuit of the beam landing due to the improvement of the geomagnetic drift. As a result, it is possible to provide a display apparatus for a television set, a computer display and others having the cathode-ray tube at lower costs.

Since the flat plate is used for the elasticity providing members 44 and 45, the material cost is reduced in comparison with a conventional flame using the square timber. Since the flat plate is used for the elasticity providing members 44 and 45, the welding condition is superior in comparison with a conventional flame using the squared one. In case of welding the spring holder 55 and others, the welding is stably performed with the small electric current, and the attrition of the welding electrode can be prevented.

The flat plate used for the elasticity providing members 44 and 45 has a larger surface area compared with the squared one, and it has superior characteristics of releasing heat. Therefore, it is easy to control the heat of the color selection mechanism at the production process of the cathode-ray tube. For example, after welding the spring holder, when the welded portion is cooled down to the room temperature, this time can be shortened. In other cases, blackening processing is performed on the color selection mechanism in a high temperature furnace and then, when cooled down to the room temperature, this time can be shortened.

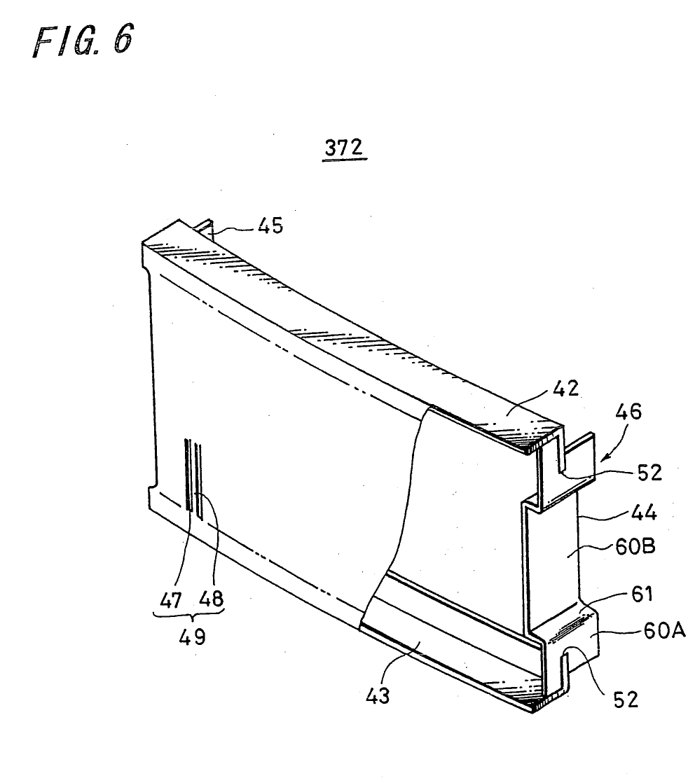

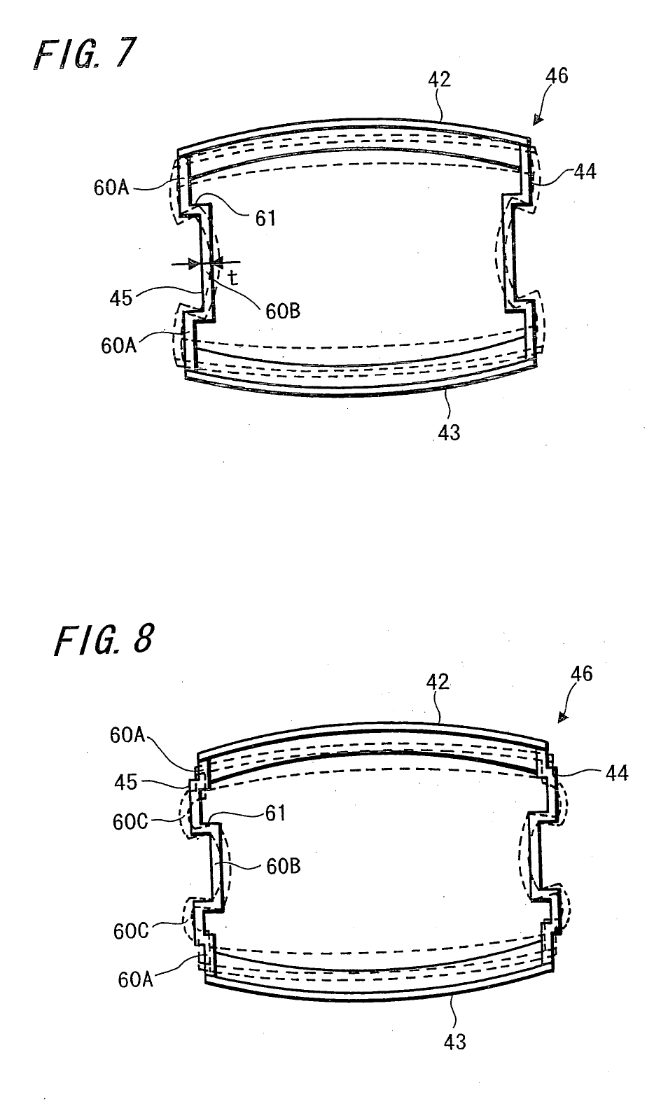

FIGS. 6 and 7 show another embodiment of the color selection mechanism of the present invention. The color selection mechanism 372 according to this embodiment particularly includes the flame composed of the elasticity providing members 44 and 45 which are made of the flat plate having a stepped portion 61 in the plate thickness direction t. Other constructions than that are similar to the above described color selection mechanism 371, so that detailed explanation thereof will be omitted.

One or a plurality of the stepped portions 61 can be provided, and the various shapes of the elasticity providing members 44 and 45 can be considered. It is preferable to symmetrically provide the stepped portions 61 for the pair of elasticity providing members 44 and 45, respectively. In this embodiment, the stepped portion 61 is formed with the bend portion 60B that projects toward the side where the pair of elasticity providing members 44 and 45 are opposite to each other, at the center of the plane surface of the elasticity providing members 44 and 45, while the portion 60A closest to both ends thereof is set as the standard position. The solid line shows the state before the flame is pressurized and the broken line shows the state after the flame is pressurized.

FIG. 8 shows the flame 46 constituting the color selection mechanism 372 of this embodiment, particularly shows another embodiment of the elasticity providing members 44 and 45 thereof. In this flame 46, the stepped portion 61 is symmetrically formed with the bend portion 60B that projects toward the side where the pair of elasticity providing members 44 and 45 are opposite to each other at the center of the plane surface of the elasticity providing members 44 and 45, respectively and with bend portions 60C that project on the opposite side at the ends of the plane surface, while the portion 60A closest to both ends thereof is set as the standard position. The solid line shows the state before the flame is pressurized and the broken line shows the state after the flame is pressurized.

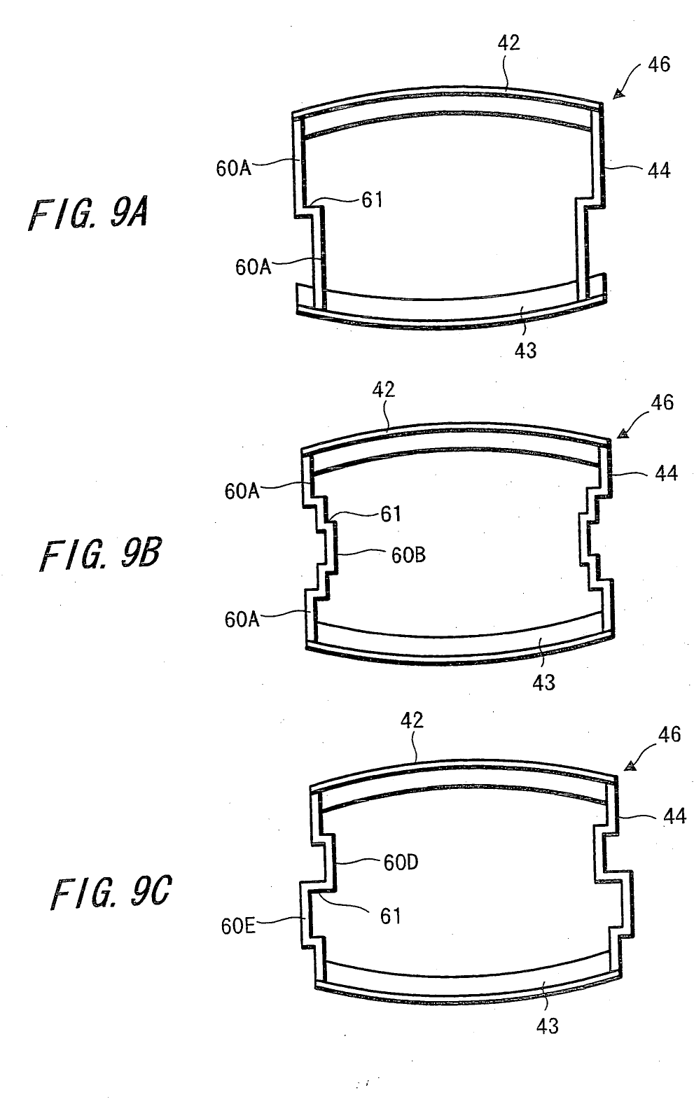

FIGS. 9A through 9C show the flame 46 constituting the color selection mechanism 372 of this embodiment, particularly show further another embodiment of the elasticity providing members 44 and 45 thereof.

In this flame 46 shown in FIG. 9A, the hook-shaped stepped portion 61 is formed symmetrically so as to project in the plate thickness direction halfway on the plane surface of the pair of elasticity providing members 44 and 45, respectively, while the portion 60A closest to both ends thereof is set as the standard position.

In this flame 46 shown in FIG. 9B, the stepped portion 61 is respectively formed symmetrically with the bend portion 60B having a plurality of steps that project at the central portion of the plane surface of the pair of elasticity providing members 44 and 45 to the side where the elasticity providing members 44 and 45 oppose each other, while the portion 60A closest to both ends thereof is set as the standard position.

In this flame 46 shown in FIG. 9C, the stepped portion 61 is symmetrically formed with two adjacent bend portions 60D and 60E that project in the opposite directions to each other on the plane surface of the pair of elasticity providing members 44 and 45, respectively, while the portion 60A closest to both ends thereof is set as the standard position.

Hereupon, in the above respective modified embodiments, the shape of the stepped portion or bend of the elasticity providing members 44 and 45 can be made that of projecting in the reverse directions.

According to the color selection mechanism 372 of this embodiment, when the elasticity providing members 44 and 45 are formed of the flat plate with the stepped portion 61 in the thickness direction of the plate, the moment force is imposed by the stepped portion 61 or the bending portion 60F., and the elasticity providing members 44 and 45 can further be deformed in the thickness direction of the plate, when the turnbuckle is imposed on the flame 46. Accordingly, the elasticity providing members 44 and 45 of the flame 46 can be deformed flexibly in comparison with the above-described color selection mechanism 371. Other than that, the color selection mechanism 372 has the similar effectiveness to the above color selection mechanism 371.

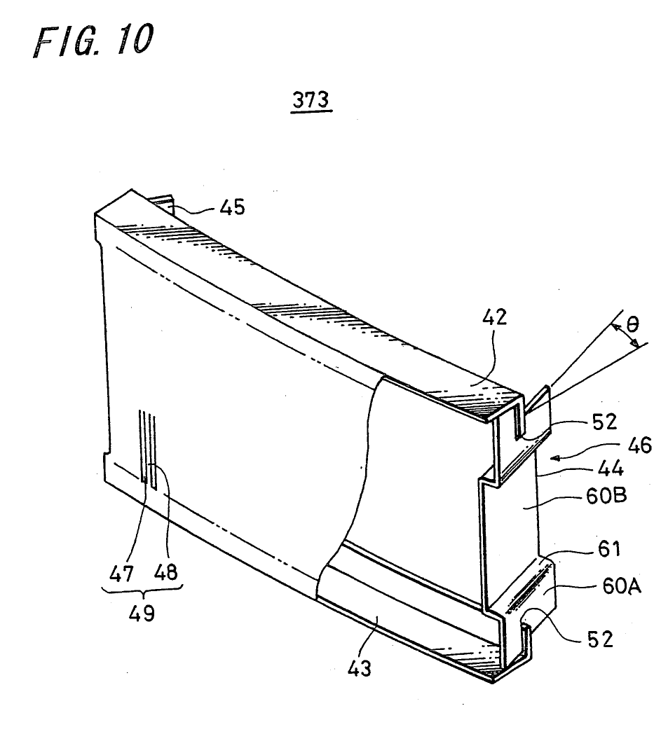

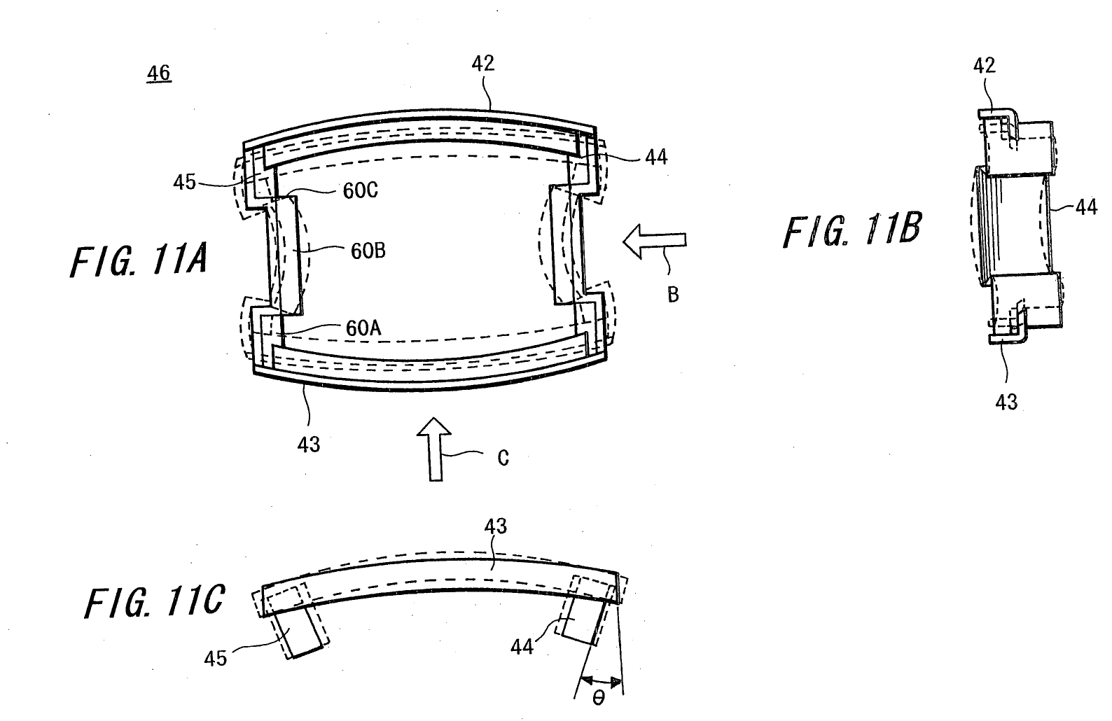

FIGS. 10 and 11 show further another embodiment of the color selection mechanism 37 of the present invention. In a color selection mechanism 373 according to this embodiment, the pair of elasticity providing members 44 and 45 constituting the flame 46 are formed particularly with the flat plate having the stepped portion 61 in the plate thickness direction, and are inclined and attached to the supporting members 42 and 43 such that an angle 0 between the surface of the flat plate and the normal of the center of the color selection mask becomes a requiring angle.

The angle θ can be selected in the range of 0°<θ<90°. Preferably, the angle θ can be selected in the range of 0°<θ<60° to secure the strength of the elasticity providing members. Further preferably, the angle θcan be selected in the range of 0°<θ<45° so as not to disturb the incident of the beam. Furthermore preferably, the angle θcan be selected in the range of 10°<0<45° to easily control the change of grill height direction GH.

Other than that, for example, the shape of the supporting members 42, 43, the welding between the elasticity providing members 44 and 45 and the supporting members 42 and 43, the method of providing the color selection mask with tension, and other constructions are similar to those of the color selection mechanism 371 explained in the above-described FIGS. 2 through 5, so that redundant explanation will be omitted.

As an example, the elasticity providing members 44 and 45 are formed with the flat plate similar to that shown in the above-described FIGS. 6 and 7, in which the stepped portion 61 is respectively formed symmetrically at the central portion with the bend portion 60B that projects convexly in desired width toward the side where the pair of elasticity providing members 44 and 45 oppose each other, and the elasticity providing members 44 and 45 are inclined and welded to the supporting members 42 and 43 at an angle θ of 30°, and then the flame is composed. The color selection mask 49 is provided with tension on this flame 46 by imposing turnbuckle.

In the color selection mechanism 373 of this embodiment, when viewed the state of flame 46 after the deformation by the pressure, that is, after the color selection mask 49 is provided with tension, the center of the elasticity providing members 44 and 45, for example, is bent and deformed in the plate thickness direction so as to convexly project toward the side of the elasticity providing members 44 and 45 opposing each other, as shown in the broken line of FIG. 11A (the solid line is the flame shape before pressurized). The both end portions are bent and deformed convexly in the plate thickness direction on the same side as the center portion or on the opposite side thereto in accordance with the deformation of the supporting members 42 and 43. When seen from an arrow B direction of the FIG. 11A, as shown in FIG. 11B, the bend portion 60B at the center of the elasticity providing members 44 and 45 is deformed in the direction of coming closer to the color selection mask 49. On the other hand, as mentioned above, due to the difference between the positions of the gravity axis o of the elasticity providing members 44 and 45 and the gravity axis o′ of the color selection mask 49, when the color selection mask is provided with tension, the moment force operates at the elasticity providing members 44 and 45, and the whole of the elasticity providing members 44 and 45 is bent and deformed in the plate width direction and on the opposite side of the color selection mask 49. Accordingly, in the elasticity providing members 44 and 45, there exists the position where the amount of the bend and deformation caused by the turnbuckle and the amount of the reverse bend and deformation when provided the color selection mask 49 with tension are cancelled, so that the amount of deformation becomes zero. The position with zero amount of bending exists at the bend area 60B at the center or the both end area 60C. Mainly, it exists at the bend area 60B of the center

The composition in which the elasticity providing members 44 and 45 are inclined and attached to the supporting members 42 and 43 at the angle θ can be applied to the color selection mechanism with the flame 46 as mentioned in the above FIGS. 3, and 9A through 9C. In those cases, in the elasticity providing members 44 and 45 after provided the color selection mask 49 with tension, the position with the zero amount of bending exists.

In this embodiment, at the flame of the color selection mechanism 373 a supporting means for the panel, for example, the support spring is welded through a spring holder, and the supporting means for the elasticity providing members, in this embodiment the spring holder, is welded at the position of the zero amount of the bending. However, the support spring is attached such that the plate surface of support spring is along with the tube axis similarly to a conventional one.

According to the color cathode-ray tube 31 including the color selection mechanism 373 of this embodiment, when the color selection mask 49 is thermally expanded by the electron beam on the operation, the tension of the elasticity providing members 44 and 45 of the flame 46 is released; however, since the spring holders of the elasticity providing members 44 and 45 are attached to the position of the zero amount of bending at the elasticity providing members 44 and 45, the position of the color selection mask in the direction of the tube axis is not changed before and after the thermal expansion, so that the change of grill height can be made zero. Thus, the characteristic of the temperature drift is further improved. Further, the same effectiveness as explained in the above-described color selection mechanism 371 can be obtained.

In the above embodiment, the support spring is attached to the flame through the spring holder, as other means, the support spring can be directly attached to the flame.

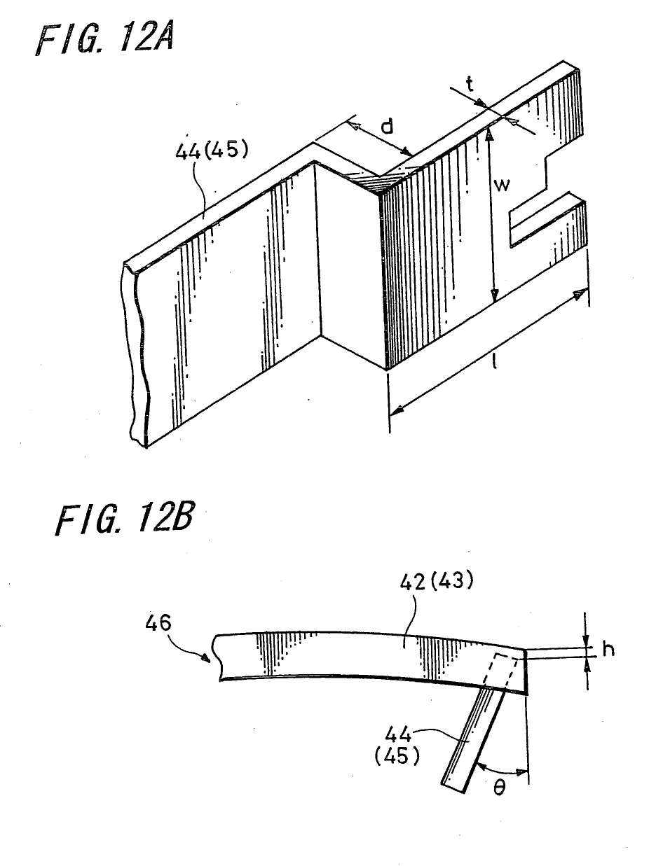

In the above mentioned embodiment, there are six conditions given to the elasticity providing members 44 and 45, that is, six main parameters of the design, as follows. These design parameters are the plate thickness t, the plate width w, the amount of bending d of the stepped portion, the position of the bending of the stepped portion, the angle θ between the normal of the center of the color selection mask and the plate surface of the elasticity providing member of the flat plate forming the elasticity providing members 44 and 45 shown in FIGS. 12A, 12B, and the height h in which the elasticity providing member is attached to the supporting members.

By appropriately selecting those design parameters, the amount of the deformation m of the supporting members 42 and 43 moving in the direction of the panel when pressurized, can be controlled, so that it becomes possible to design the color selection mechanism having the optimum characteristics of the temperature drift.

When each flame 46 in accordance with the above mentioned embodiments is employed, on the pressurization at the process of turnbuckle, the amount of deformation m of the supporting members 42 and 43 that moves toward the direction of the panel can be designed freely. Theoretically, this amount of deformation can be made zero. Therefore, even if the color selection mask 46 is expanded by heat in the cathode-ray tube, the grill height GH may not change or may change extremely small if it is changed, so that the temperature drift in accordance with the change of grill height GH can be reduced close to zero, as small as possible.

The color selection mechanism of the present invention is suitable for use in large-sized and hi-definition type color cathode-ray tubes.

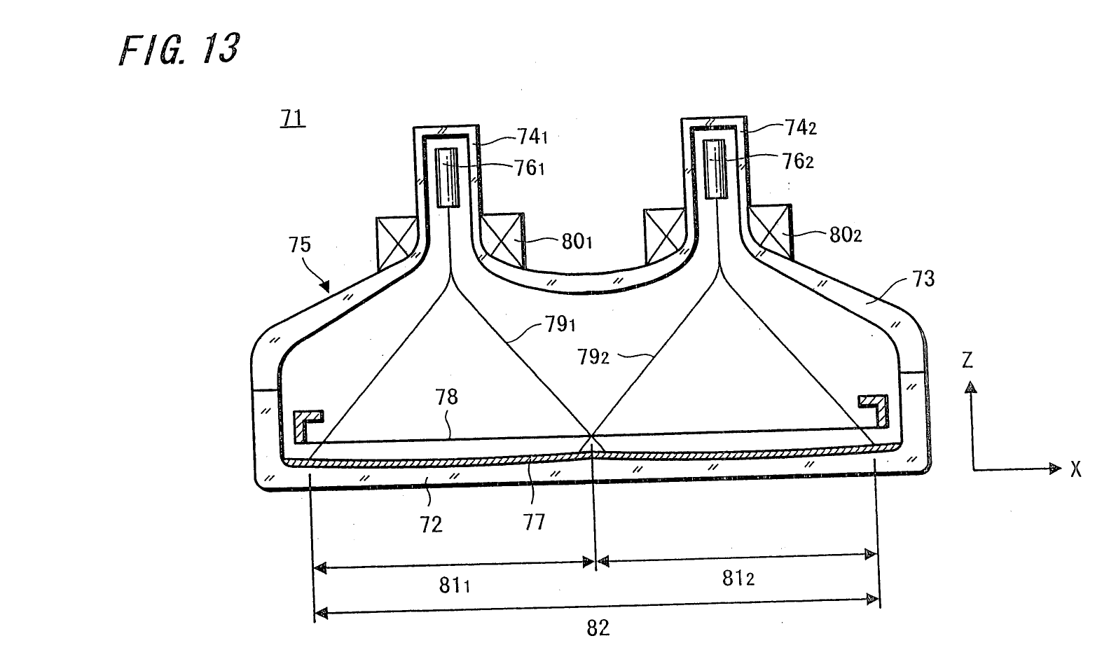

FIG. 13 shows another embodiment of the present invention, when the color cathode-ray tube according to the present invention is applied to the color cathode-ray tube having multiple electron guns. In this embodiment, there are provided the color cathode-ray tube having two electron guns.

A color cathode-ray tube 71 in accordance with this embodiment includes a plurality of neck portions, in this embodiment, two neck portions 74 [74₁, 74₂] and electron guns 76 [76₁, 76₂] respectively. Specifically, a tube body 75 consists of a panel 72 forming a large-sized screen, a funnel 73 joined to this panel 72, and two neck portions 74 [74₁, 74₂] joined to the funnel 73. The electron gun 76₁ and 76₂ are disposed in the neck portion 74₁ and 74₂, respectively, and a color selection mechanism 78, for example, an aperture grill, a shadow mask (slot mask) or the like is disposed opposing a color fluorescent screen 77 on the inner surface of the panel 72. This cathode-ray tube 71 has the construction in which the whole picture can be displayed on a large screen area formed by combining a plurality of small screens, in this example, two small screens. On the outside of the tube body 75, the deflection yokes 80 [80₁, 80₂] are disposed from each of neck portions 74₁, 74₂ to the funnel 73.

The panel 72 is integrally formed and has the long axis in the horizontal direction of the screen, and the short axis in the vertical direction of the screen. On the inside surface of the panel 72, a plurality of small screen areas 81 that are scanned by electron beams emitted from the each of the electron guns 76 are formed in accordance with the number of the electron guns 76. In this embodiment, two small screen areas 81₁, 81₂ are formed, and the large screen area is formed by the combination of the small screen areas 81₁, 81₂. In this embodiment, the electron beams 79₁, 79₂ from each of the electron guns 76₁, 76₂ scan an area adjacent to the next small screen area with partially overlapped, that is, respectively scan the boundary of the two small screen 811, 812 with partially overlapping. The color selection mechanism 78 is formed in common with respect to the large screen area 82 of the panel 72. In this case, the fluorescent screen 77 is constructed by vertically arraying each color fluorescent layer in long stripe shape in the horizontal direction, along the horizontal direction of the large screen 82. The color selection mask of the color selection mechanism 78, as mentioned later, is formed having long slits or long slots (both are the beam apertures) in the horizontal direction of the large screen 82.

In such color cathode-ray tube 71 having two electron guns, each of the electron beams 79₁, 79₂ from each of the electron guns 76₁, 76₂ is emitted to display a half of the picture of the picture screen. The electron beams 79₁, 79₂ are vertically scanned respectively as the line scanning, and also scanned from the end to the center of the each screen in the horizontal direction of the screen as the field scanning, and overlaps with each other around the central area. In this cathode ray tube 71, the vertical deflection of the electron beams 79₁, 79₂ corresponds to so called the line deflection, and the horizontal deflection corresponds to so called field deflection.

Hereupon, in the color cathode ray tube 71 having two electron guns, each grid element of the color selection mask of the color selection mechanism (aperture grill in this embodiment) has the length twice as long as the conventional ones, and also the amount of heat given to the color selection mask by electron beams from the two electron guns on the operation is twice, the thermal expansion of the color selection mask simply becomes four times greater than conventional aperture grills, and measures against the temperature drift become extremely severe than the conventional ones.

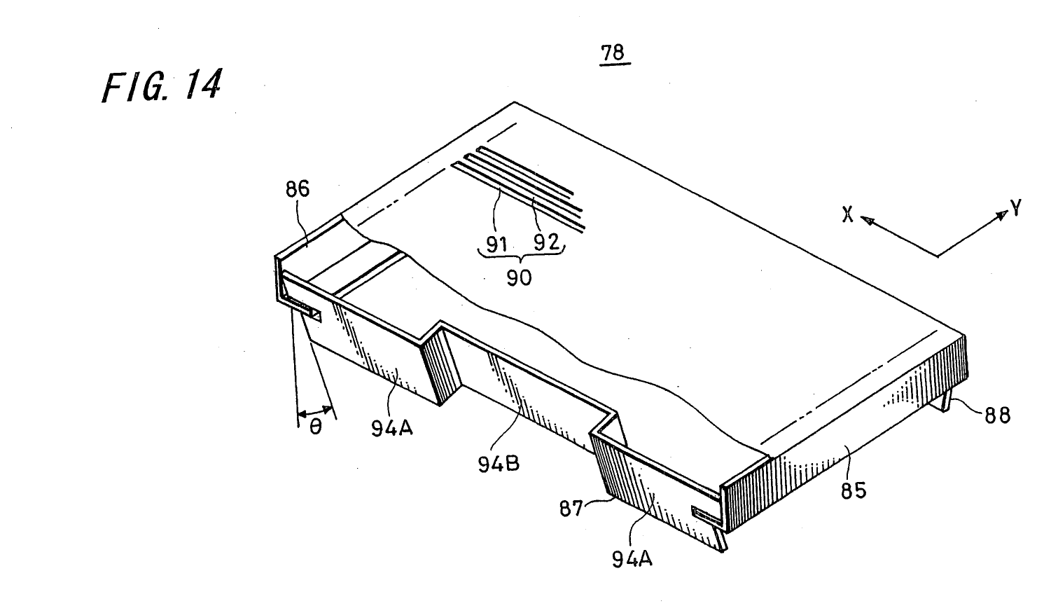

In this embodiment, the color selection mechanism 78 of the color cathode ray tube 71 having these two electron guns is composed of the above mentioned color selection mechanism according to the present invention. Specifically, as shown in FIG. 14, this color selection mechanism 78, an aperture grill in this embodiment, is composed of a metal flame 89 formed of a pair of supporting members 85 and 86 opposing each other and elasticity providing members 87 and 88 made of a flat plate and joined between the ends of the supporting members, and the color selection mask 90 is provided with tension on the metal flame 89. In the color selection mask 40 a number of minute long stripe-shaped grid elements 91 in the horizontal direction of the screen are arrayed along the vertical direction of the screen, and a long slit (beam aperture) 92 is formed in the horizontal direction of the screen between adjacent grid elements 91. The flame 89 in this embodiment has the same construction as that explained in the above FIG. 11. Specifically, the elasticity providing members 88 and 89 made of a flat plate, and having the bending portion 94B that projects toward the side where the elasticity providing members 88 and 89 opposing each other, that is, having so called a stepped portion, while the portion closest to the end of the flat surface is set as the standard portion 94A, are inclined at an angle θ of 30°, for example, and attached to the supporting members 85 and 86 having approximately L-shaped cross section.

According to the color cathode ray tube 71 having the above color selection mechanism 78 and including two electron guns, even if the color selection mask 90 is expanded by heat on the operation, since the grill height GH is, as mentioned above, the same as that before the thermal expansion, the characteristic of the temperature drift can be improved. Further, the same effectiveness as the improvement of the geomagnetic drift and others, as mentioned above, can be obtained.

In the above mentioned color selection mechanism, the elasticity providing member is made of a flat plate so that the supporting member is not deformed mainly in the direction of the tube axis at the time of the thermal expansion of the color selection mask; however, as the material of the elasticity providing members, any material that can elastically be deformed within the surface intersecting the surface having the normal of the center of the color selection mask can be used, and the color selection mechanism of the present invention can be composed of the elasticity providing members made of such materials.

In the color selection mechanism in which the elasticity providing member is made of the material elastically deformed on the surface intersecting the surface having the normal of the center of this color selection mask, the elasticity providing members can be inclined and attached to the supporting members at an requiring angle θ between the surface in which the elasticity providing members elastically deformed and the normal of the center of the color selection. In this composition, as mentioned above, at the flame after the color selection mask provided with tension, there can be obtained the position where the amount of change of deformation of the elasticity providing members becomes zero. When the supporting means for the panel is attached to the elasticity providing members at the position where the amount of change of deformation is zero, the change of grill height can be reduced to zero, even if the color selection mask is expanded by heat at the time of the operation, so that the characteristic of the temperature drift can further be improved.

The angle θ can be selected in the range of 0°<θ<90° similarly to the above-described embodiment, preferably selected in the range of 0°<θ<60°, further preferably selected in the range of 0°<θ<45°, furthermore preferably selected in the range of 10°<θ<45°.

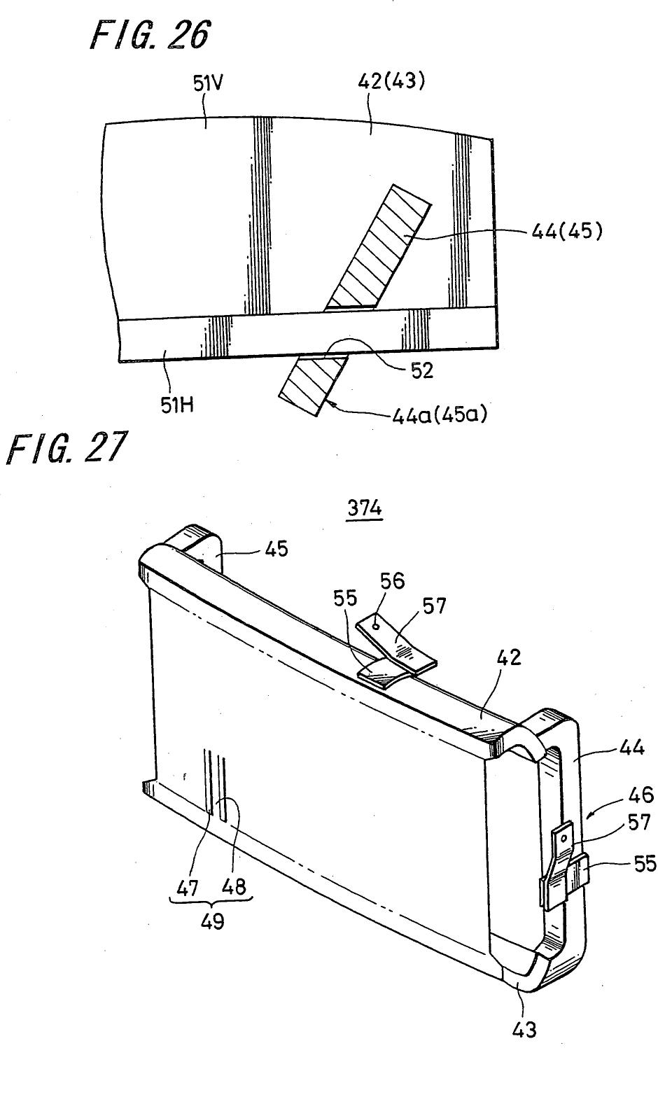

In the color selection mechanism of this embodiment in which the elasticity providing member of the flame is made of the flat plate as mentioned above, when the connection method in which the slit shaped engagement groove 52 is formed on the elasticity providing members 44, 45 to be inserted and welded to the horizontal portion 51H of the supporting members 42 and 43 as shown in FIG. 5 is employed on the joining of the supporting members and the elasticity providing members, the method is not suitable for the mass production. Particularly, in the color selection mechanisms 373, 374 as shown in the above-described FIGS. 10, 14 and so on, in which elasticity providing members 44, 45 (87, 88) made of the flat plate are disposed with inclination with respect to the supporting members 42, 43 (85, 86), the engagement groove 52 is, as shown in FIG. 26, required to be formed with tilt with respect to the plate surface 44a (45a) in the thickness direction of the plate. This inclined engagement groove 52 is required to form by cutting processing, it is difficult to make by the press processing.

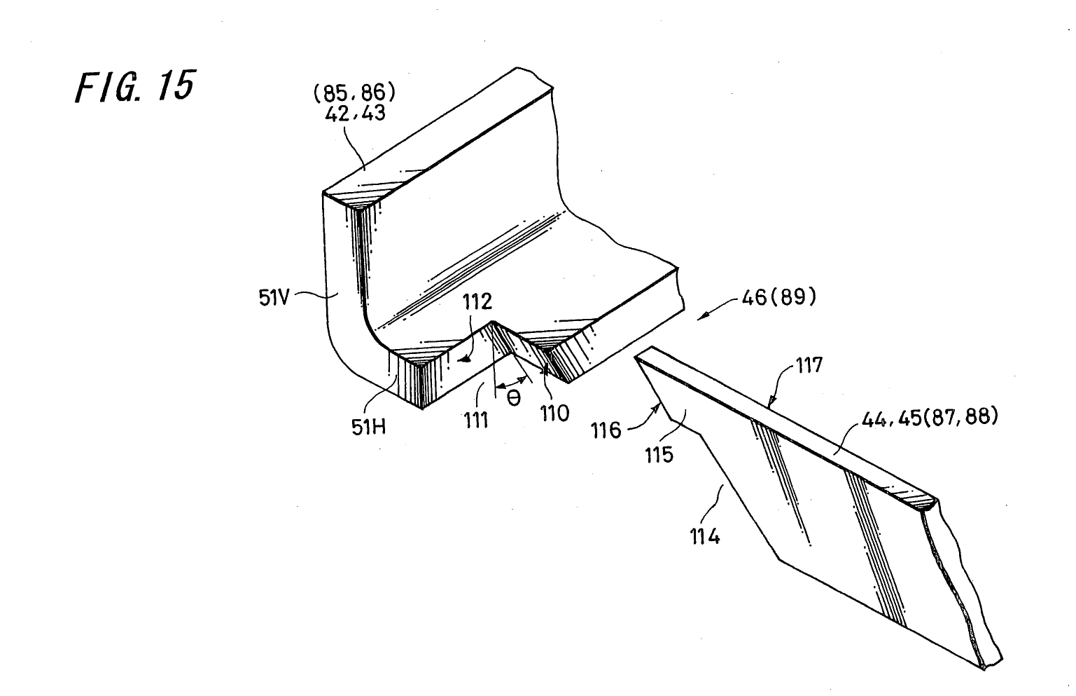

Next, referring to FIGS. 15 through 25, an embodiment of the present invention in which the mass production of the flame of the above mentioned color selection mechanism is made possible will be explained. Hereupon, FIGS. 15 through 25 only show the structure of relevant parts regarding the joint of the supporting member and the elasticity providing member.

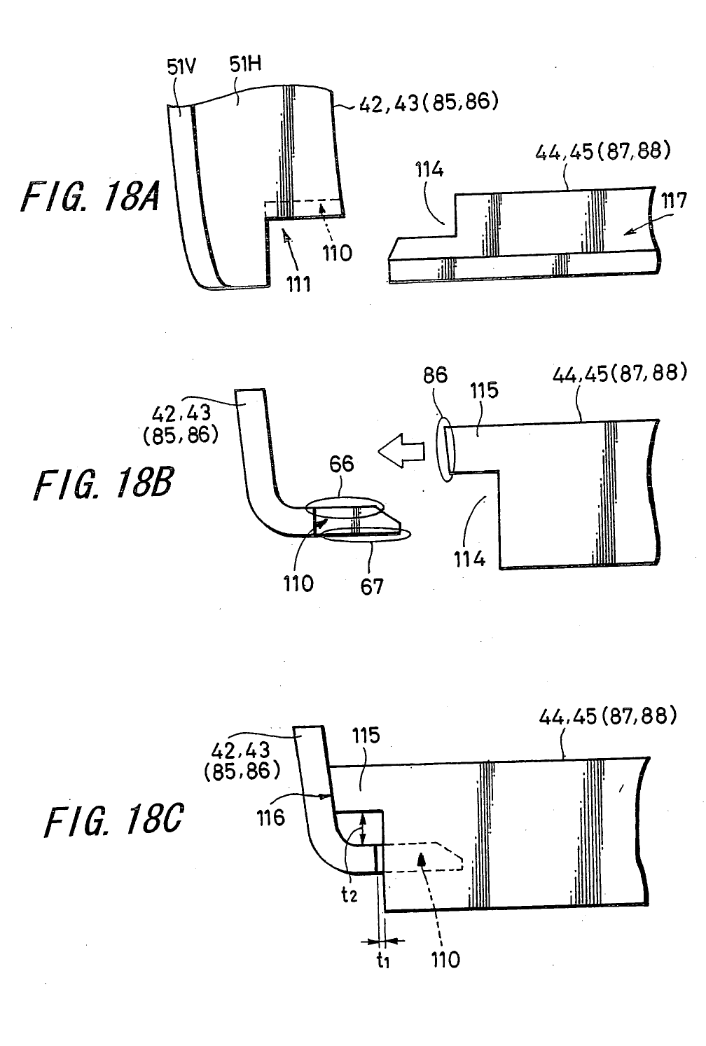

FIGS. 15 through 17 (perspective view, cross-sectional view) and FIG. 18 (plan view, side view) show an embodiment illustrating the relevant parts of the joint between the supporting members 42, 43 (or 85, 86) and the elasticity providing members 44, 45 (or 87, 88) made of the flat plate, applied to the color selection mechanism of the present invention, that is, the color selection mechanism 373, 78 corresponding to those in the above described FIGS. 10 and 14.

In the color selection mechanism according to this embodiment, on the flat plate of the elasticity providing members 44, 45 (87, 88) constituting the flame 46 (or 89) a cutaway portion 111 is provided at the portion of the supporting members 42, 43 (or 85, 86) to which the elasticity providing members 44, 45 (or 87, 88) is attached, with forming the contact surface 110 of the cutaway portion 111 where the elasticity providing members 44, 45 (87, 88) are attached to as the slope having an angle θ that corresponds to the angle θ of the elasticity providing members 44, 45 (87, 88) when attached to the supporting members 42, 43 (85, 86), and a plate surface 117 of the elasticity providing members 44, 45 (87, 88) is brought in contact with the contact surface 110 of the cutaway portion 111 of the supporting members 42, 43 (85, 86) to join the supporting members 42, 43 (85, 86) and the elasticity providing members 44, 45 (87, 88).

Further, explanation in detail will be provided. FIGS. 15, 18A, 18B are exploded views of the relevant part of the supporting member and the elasticity providing member constituting the flame of the color selection mechanism according to the present invention, and FIGS. 16, 17, 18C are views showing assembled states of the relevant part of the flame formed by joining the supporting member and the elasticity providing member. The supporting members 42, 43 (or 85, 86) have approximately L-shaped cross section formed with the vertical portion 51V welded to the color selection mask 49 (or 90) and the continuous horizontal portion 51H thereto. At the both ends of the horizontal portion 51 where the elasticity providing members 44, 45 (or 87, 88) are attached to, the square-shaped cutaway portion 111 is formed. One side surface of the inner surfaces of this cutaway portion 111, namely the contact surface 110 where the elasticity providing members 44, 45 (87, 88) is brought in contact with, is formed as the slope having the angle θ that corresponds to the angle θ of the elasticity providing members 44, 45 (87, 88) when attached to the supporting members 42, 43 (85, 86). The other side surface 112 is cut at approximately the right angle. On the other hand, at the both end portions of the elasticity providing members 44, 45 (87, 88) a square-shaped cutaway portion 114 is formed corresponding to the cutaway portion 111 of the supporting members 42, 43 (85, 86). While an end surface 116 of a projecting portion 115 of the cutaway portion 114 of the elasticity providing members 44, 45 (87, 88) is brought in contact with the inner surface of the vertical portion 51V of the supporting members 42, 43 (85, 86), both members are joined to provide a gap t1 between the inner surface 117 of the cutaway portion 114 of the elasticity providing members 44, 45 (87, 88) and the other surface 112 of the horizontal portion 51H of the supporting members 42, 43 (85, 86). Further, a gap t2 is formed between the projecting portion 115 and the upper surface of the horizontal portion 51H.

With respect to the supporting members 42, 43 (85, 86), for example, after the cutaway portion 111 is formed by the press processing in the direction vertical to the horizontal portion 51H, the contact surface 110 with an angle is formed by the press processing in an oblique direction. The cutaway portion 114 of the elasticity providing members 44, 45 (87, 88) is formed by the press processing of the vertical direction to the surface of the plate.

When the flame 46 (89) is assembled, as shown in FIGS. 16, 17, and 18C, the cutaway portion 114 of the elasticity providing members 44, 45 (87, 88) is inserted to the cutaway portion 111 of the supporting members 42, 43 (85, 86); the end surface 116 of the projecting portion 115 of the elasticity providing members 44, 45 (87, 88) is brought in contact with the inner surface of the vertical portion 51V of the supporting members 42, 43 (85, 86); the plate surface 117 of the elasticity providing members 44, 45 (87, 88) is brought in contact with the inclined contact surface 110 at the angle θ of the cutaway portion 111 of the horizontal portion 51H of the supporting members 42, 43 (85, 86); and then in that state, both members are welded by, for example, the arc welding method or the like. Thus, the elasticity providing members 44, 45 (87, 88) are attached to the supporting members 42, 43 (85, 86) with the inclined angle θ, and the targeted flame 46 (89) is manufactured. By providing the color selection mask 49 (90) on the flame 46 (89) with tension, the targeted color selection mechanism. 373 or 78 is obtained.

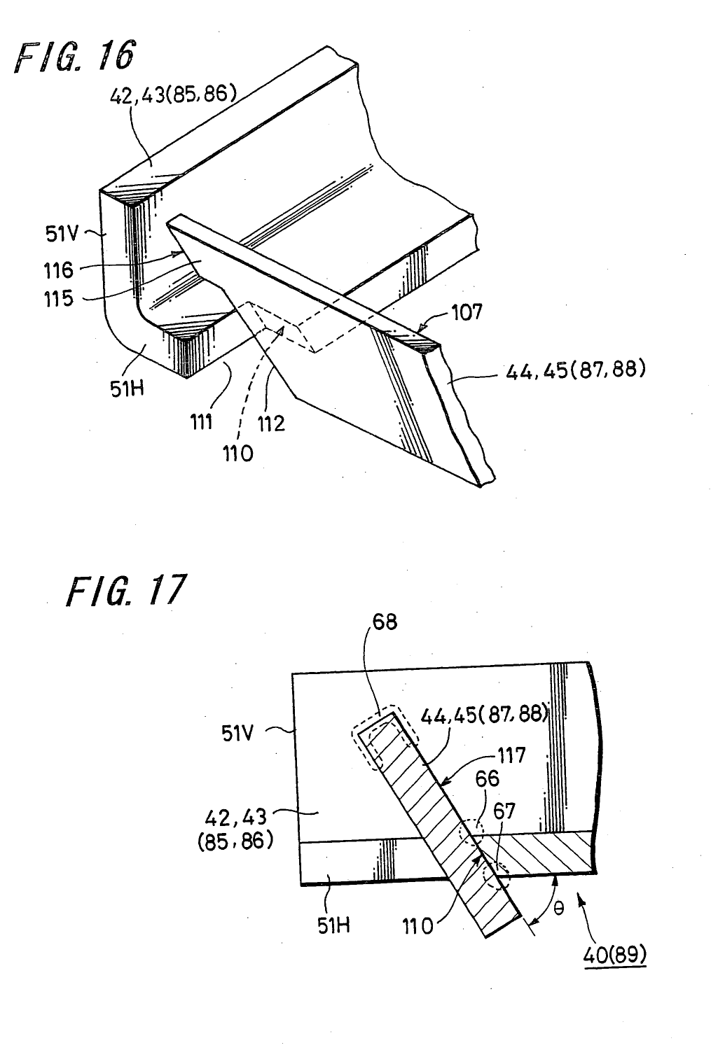

The welding portions may be, as shown for example in FIG. 17, a portion 66 where the upper surface of the horizontal portion 51H in the vicinity of the contact surface 110 of the supporting members 42, 43 and the elasticity providing members 44, 45 (87, 88) are crossed, a portion 67 where the rear surface of the horizontal portion 51H in the vicinity of the contact surface 110 and the elasticity providing members 44, 45 (87, 88) are crossed, and a portion 68 where the upper and both side surfaces of the projecting portion 115 of the elasticity providing members 44, 45 (87, 88) and the inner surface of the vertical portion 51V of the supporting members 42, 43 (85, 86) are crossed.

According to the color selection mechanism of the embodiment of the present invention, the cutaway portion 111 having the contact surface 110 with the requiring angle θ is formed on the supporting members 42, 43 (85, 86) by the press processing, the cutaway portion 114 is formed at the both ends of the elasticity providing members 44, 45 (87, 88) by the press processing, the plate surface 117 on the elasticity providing member side is brought in contact with the contact surface 110 on the supporting member side and joined, and thus flame 46 (89) is formed. As described above, in the color selection mechanisms 373, 78, since the joint portions are processed only by the press processing without the above-described cutting processing, when the flat plate elasticity providing members 44, 45 (87, 88) are attached at the requiring angle θ to the supporting members 42, 43 (85, 86) with the cross section approximately L-shaped, the joint portions can be the structure suitable for mass production at lower costs. In this structure, since the turnbuckle for the flame when providing the color selection mask with tension can be performed by pressurizing the joint portions between the supporting members and the elasticity providing members, the turnbuckle is efficiently imposed.

Therefore, with this embodiment, highly reliable color selection mechanisms in which the amount of the temperature drift is further suppressed, and consequently, the color cathode-ray tube therewith can be obtained at lower costs on mass production basis.

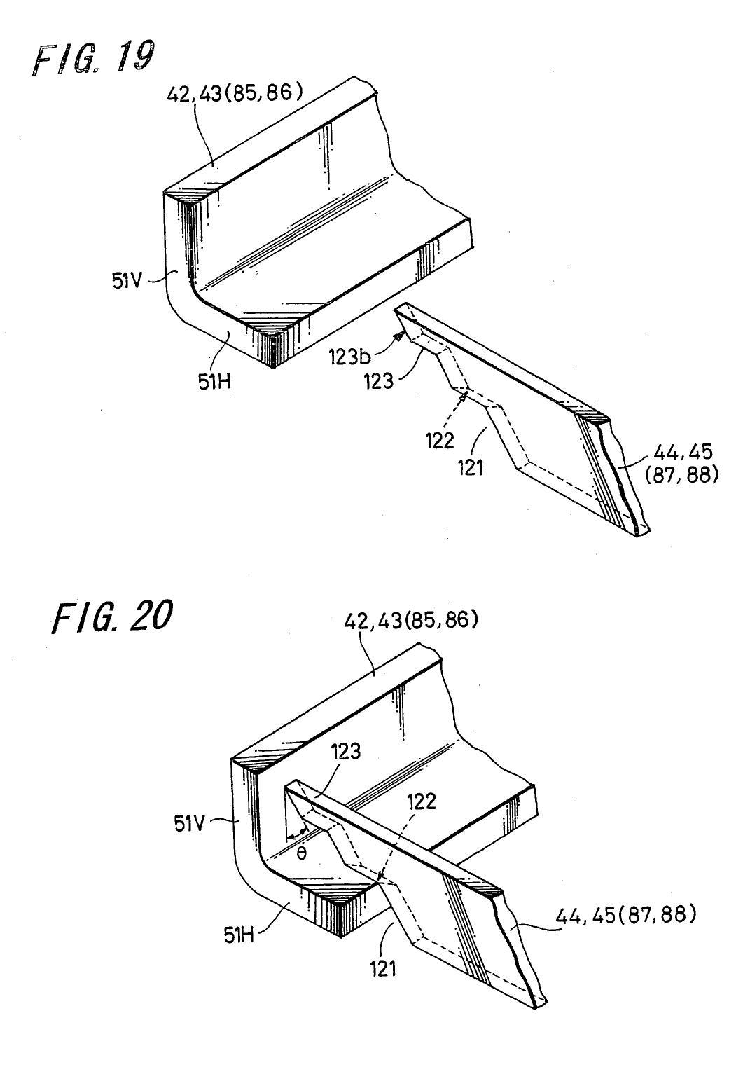

FIGS. 19 through 21 (perspective view, cross-sectional view) and FIG. 22 (side view) show another embodiment applied to the color selection mechanism of the present invention, namely, applied to the color selection mechanisms 373, 78 corresponding to those shown in FIGS. 10 and 14, of the relevant part of the joint portion between the supporting members 42, 43 (or 85, 86) and the elasticity providing members 44, 45 (or 87, 88) made by the flat plate.

In the color selection mechanism according to this embodiment, on the flat plate of the elasticity providing members 44, 45 (87, 88) constituting the flame 46 (or 89) a cutaway portion 121 is provided at the portion of the elasticity providing members 44, 45 (or 87, 88) where the supporting members 42, 43 (or 85, 86) are attached to, with forming a contact surface 122 of the cutaway portion 121 as the slope having an angle θ that corresponds to the angle θ of the elasticity providing members 44, 45 (87, 88) when attached to the supporting members 42, 43 (85, 86), and the contact surface 121 of the elasticity providing member is brought in contact with the upper surface of the horizontal portion 51H of the supporting member to join the supporting members 42, 43 (85, 86) and the elasticity providing members 44, 45 (87, 88).

Further, explanation in detail will be provided. FIGS. 19 and 22A are exploded views of the relevant part of the supporting member and the elasticity providing member of the color selection mechanism according to the present invention, and FIGS. 20, 21 and 22B are views showing the assembled states of the relevant part of the flame formed by joining the supporting member and the elasticity providing member. The supporting members 42, 43 (85, 86) have approximately L-shaped cross section formed with the vertical portion 51V welded to the color selection mask 49 (90) and the continuous horizontal portion 51H thereto.

On both ends of the flat plate of elasticity providing members 44, 45 (87, 88) the cutaway portion 121 having the shape of approximately right angle stairs is formed, respectively. A contact surface 122 of the cutaway portion 121 brought in contact with the upper surface of the horizontal portion 51H of the supporting member is formed as a slope having an angle θ corresponding to the angle of the elasticity providing members when attached to the supporting members. Other surfaces than the contact surface 122 are provided at approximately right angles. In the elasticity providing members 44, 45 (87, 88), while the contact surface 122 is brought in contact with the upper surface of the horizontal portion 51H of the supporting members 42, 43 (85, 86), an end surface of a projecting portion 123 formed of the cutaway portion 121 is brought in contact with the inner surface of the vertical portion of the supporting members 42, 43 (85, 86), and a gap t3 is formed between the horizontal end surface of the projecting portion 123 and horizontal portion 51H of the supporting members 42, 43 (85, 86), and a gap t4 is formed between the end portion of the horizontal portion 51H and the end surface of the cutaway portion 121 corresponding thereto, respectively. The cutaway portion 121 having the inclined contact surface 122 is formed by the above-described press processing.

When the flame 46 (89) is assembled, as shown in FIGS. 20, 21, and 22B, the cutaway portion 121 of the elasticity providing members 44, 45 (87, 88) is inserted to the horizontal portion 51 of the supporting members 42, 43 (85, 86); the end surface 123a of the projecting portion 123 of the elasticity providing members 44, 45 (87, 88) is brought in contact with the inner surface of the vertical portion 51V of the supporting members 42, 43 (85, 86); the inclined contact surface 122 having an angle θ of the elasticity providing members 44, 45 (87, 88) is brought in contact with the upper surface of the horizontal portion 51H of the supporting members 42, 43 (85, 86); and then in that state, both members are welded by, for example, the arc welding method or the like. Thus, the elasticity providing members 44, 45 (87, 88) are attached to the supporting members 42, 43 (85, 86) with the inclined angle θ, and the targeted flame 46 (89) is manufactured. By providing the color selection mask 49 (90) on the flame 46 (89) with tension, the targeted color selection mechanism 373 or 78 is obtained.

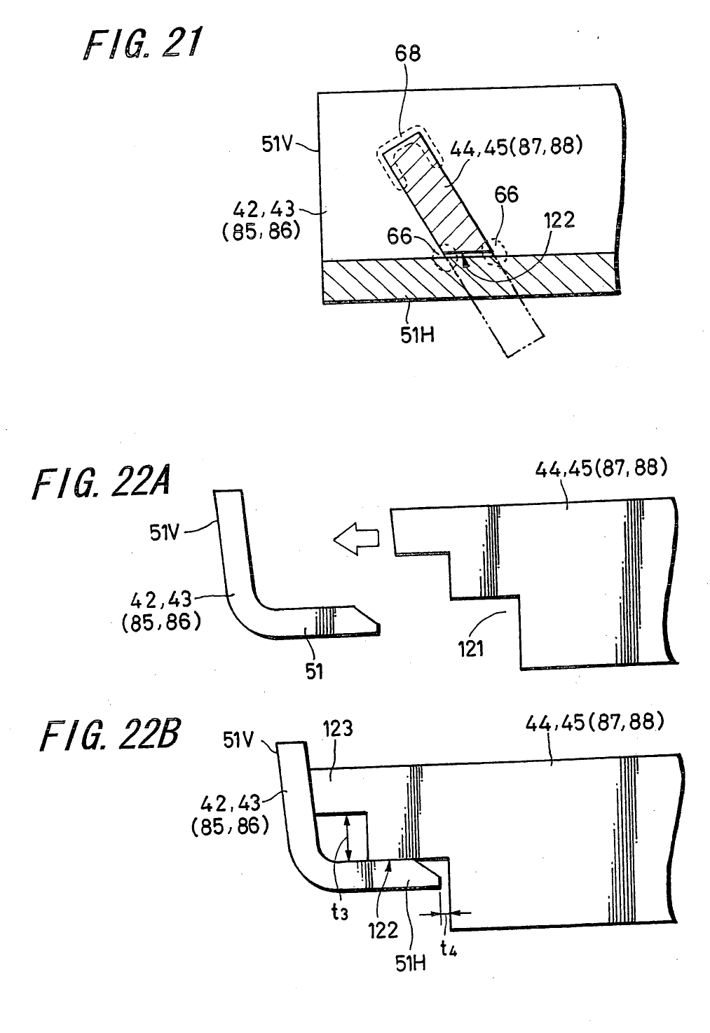

The welding portions may be, as shown for example in FIG. 21, a portion 66 where the upper surface of the horizontal portion 51H of the supporting members 42, 43 and the elasticity providing members 44, 45 (87, 88) are crossed, a portion 68 where the horizontal portion 51H of the supporting members 42, 43 and the elasticity providing members 44, 45 (87, 88) are crossed.

According to this embodiment of the present invention, the cutaway portion 121 having the contact surface 122 with the requiring angle θ is formed on the elasticity providing members 44, 45 (87, 88) by the press processing, and the contact surface 122 of the elasticity providing member side is brought in contact with the upper surface of the horizontal portion 51H of the supporting member side to be joined. As described above, since the joint portions are processed only by the press processing without cutting processing, when the flat plate elasticity providing members 44, 45 (87, 88) are attached at the requiring angle θ to the supporting members 42, 43 (85, 86) with the cross section approximately L-shaped, the joint portions can be the structure suitable for mass production at lower costs. In this structure, since the turnbuckle for the flame when providing the color selection mask with tension can be performed by pressurizing the joint portions between the supporting members and the elasticity providing members, the turnbuckle is efficiently imposed.

Therefore, with this embodiment, highly reliable color selection mechanisms in which the amount of the temperature drift is further suppressed, and consequently, the color cathode-ray tube therewith can be obtained at lower costs on mass production basis.

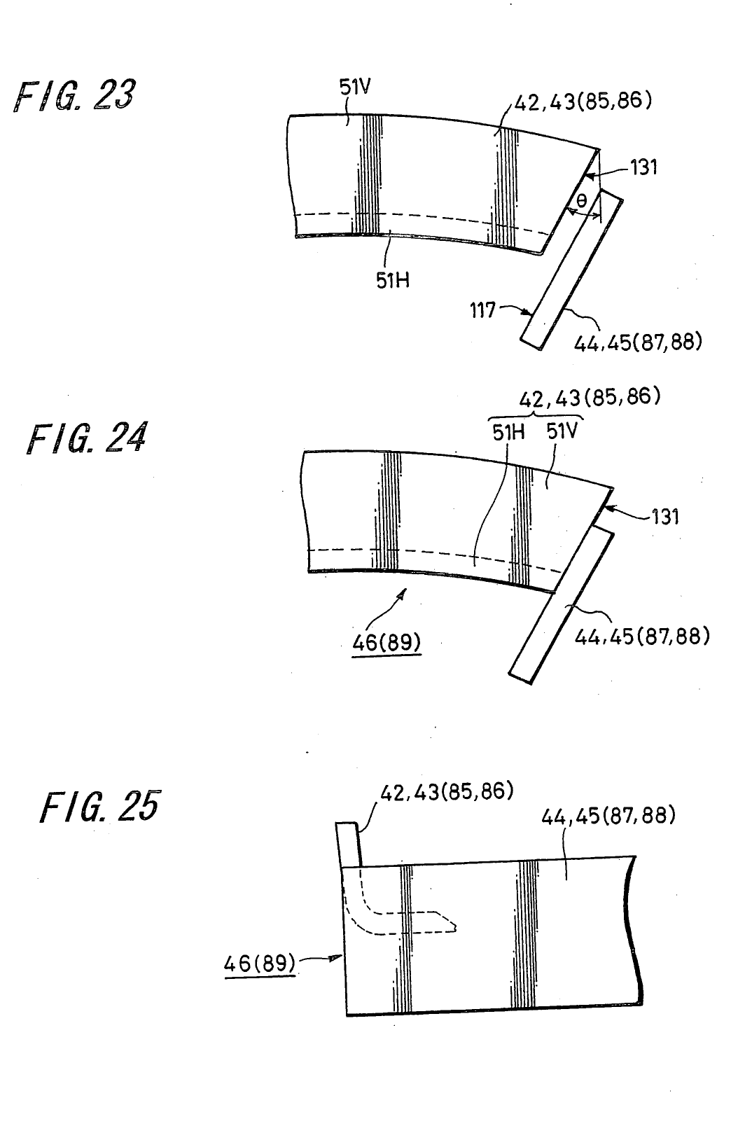

FIGS. 23 through 25 show another embodiment applied to the color selection mechanism of the present invention, namely, applied to the color selection mechanisms 373, 78 corresponding to those shown in FIGS. 10 and 14, of the relevant part of the joint portion between the supporting members 42, 43 (or 85, 86) and the elasticity providing members 44, 45 (or 87, 88) made by the flat plate.

In the color selection mechanism according to this embodiment, the elasticity providing members 44, 45 (87, 88) constituting the flame are formed of flat plates, an end surface 131 of the supporting members 42, 43 (or 85, 86) having the cross section approximately L-shaped, where the elasticity providing members 44, 45 (87, 88) are attached to, is formed as a slope having an angle θ that corresponds to the angle θ of the elasticity providing members 44, 45 (87, 88) when attached to the supporting members 42, 43 (85, 86), and a plate surface 117 of the elasticity providing member is brought in contact with the whole of the inclined end surface 131 of the supporting members to join the supporting members 42, 43 (or 85, 86) and the elasticity providing members 44, 45 (or 87, 88) by, for example, the arc welding or the like. The welding portion may be the portion along the L shape of the supporting members 42, 43 (85, 86). By providing the color selection mask 49 (90) with tension on this flame 46 (89) the color selection mechanism 373 or 78 is produced.

According to this embodiment of the present invention, the both end surfaces 131 of the supporting members 42, 43 (85, 86) with the cross section approximately L-shaped is formed as a slope having an angle θ, and to this end surface 131 the plate surface of the elasticity providing member is brought in contact with to form the flame. Therefore, as described above, since the joint portion is processed only by the press processing without cutting processing, when the flat plate elasticity providing members 44, 45 (87, 88) are attached at the requiring angle Oto the supporting members 42, 43 (85, 86) with the cross section approximately L-shaped, the joint portion can be the structure suitable for mass production at lower costs.

Therefore, with this embodiment, highly reliable color selection mechanisms in which the amount of the temperature drift is further suppressed, and consequently, the color cathode-ray tube therewith can be obtained at lower costs on mass production basis.

In the above embodiments, the structure of the joint portion shown in FIGS. 15 through 25 is applied to the color selection mechanism 373, 78 in which the elasticity providing members of the flat plate is provided with inclination with respect to the supporting members; however, the structure can be applied to the color selection mechanism 371, 372 in which the above described elasticity providing members of the flat plate is disposed at right angles (θ=0°) without tilt.

In the above color selection mechanisms according to the embodiments of the present invention, of the supporting members and the elasticity providing members constituting the flame, the elasticity providing member is formed with the flat plate, and the amount of change of the grill height GH after the thermal expansion is made to reduce to zero as small as possible to improve the characteristic of the temperature drift. On the other hand, of the supporting members and the elasticity providing members constituting the flame, by changing the structure of the supporting members, the amount of change of the grill height GH after the thermal expansion can be reduced as small as possible to zero, and the characteristic of the temperature drift can be improved. Next, an embodiment of this case will be explained.

FIG. 27 shows further another embodiment of the color selection mechanism 37 according to the present invention. A color selection mechanism 374 according to this embodiment includes, a metal flame 46 having a pair of supporting members 42 and 43 with approximately L-shaped cross section inclined as an elbow shape and a pair of elasticity providing members 44 and 45 joined between both ends of the supporting members 42, 43, in which provided with tension a color selection mask 49 having a number of slit (beam aperture) 47 formed at the thin metal plate as arranged in the horizontal direction of the screen and having a minute stripe shaped so called grid element 48 formed between the adjacent slits 47. In this embodiment, the elasticity providing members 44 and 45 are formed by pressing the square member into the U shape, similarly to the conventional method.

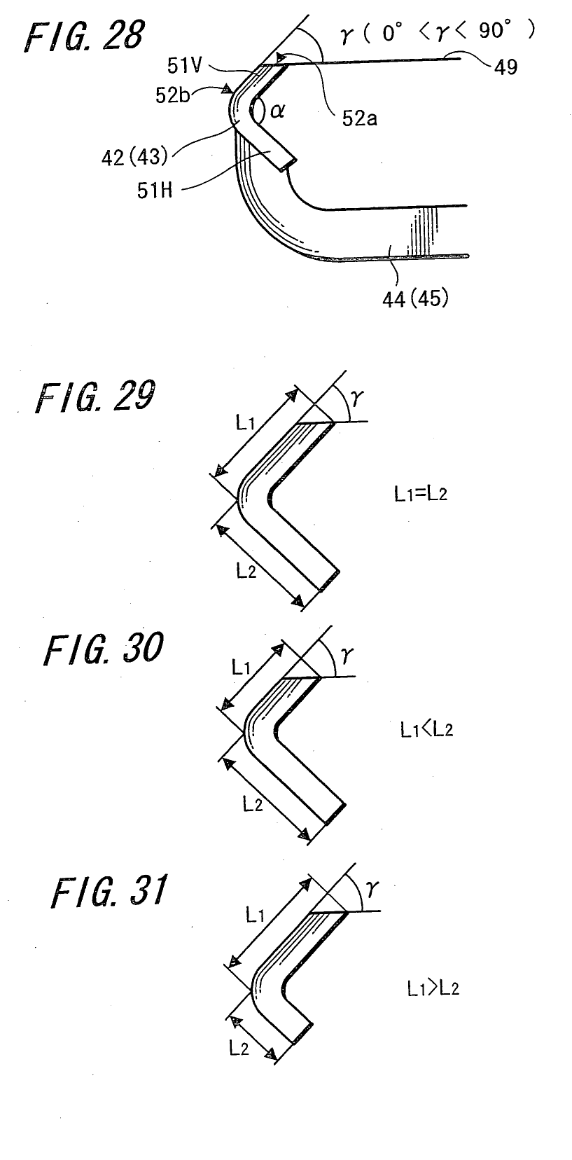

The supporting members 42, 43 have, as shown in FIG. 28, approximately L-shaped cross section that is composed of one side portion 51V where the color selection mask 49 is welded to and the other portion 51H that is continued therefrom. An angle ,, between one side portion 51V and the other side portion 51H is preferably selected from about 90° to 95°, though, it does not limit to this angle. The supporting members 42 and 43 having approximately L-shaped cross section are inclined toward the direction in which the change of the grill height GH is reduced, as later described, and joined to the elasticity providing members.

Specifically, the supporting members 42, 43 are inclined and disposed at an angle γ between a tangent line of a side surface 52b of one side portion 51V to which the color selection mask 49 is attached and the plane surface that is formed by the four corner of the color selection mask 49 in the range of 0°<γ<90°. As the flame 46, the supporting members 42, 43 are joined to the elasticity providing members 44, 45 at an angle γ between a side surface 52b of the side portion 51V and a surface of the supporting members 42, 43 to which the color selection mask 49 is attached, that is, a surface 52a of the side portion 51V in the range of 0°<γ<90°. Whichever value is selected as the length L1 of one side portion 51V and the length L2 of the other side portion constituting approximately L-shaped cross section, the angle θ at which the change of the grill height GH is zero definitely exists in the range of 0°<γ<90°.

When the lengths L1, L2 of one side portion 51V and the other portion 51H of the supporting members 42, 43 constituting the cross section approximately L-shaped, are equally set as L1=L2, an angle γ is preferably set to 20≦γ≦45° (refer to FIG. 29). If not selected in this range, the balance is lost and the change of the grill height GH does not come to zero.

When the lengths L1, L2 of one side portion 51V and the other portion 51H of the supporting members 42, 43 constituting the cross section approximately L-shaped, are set as L1<L2, an angle Y is preferably set smaller than the above case of L1=L2 (see FIG. 30). The reason is the same as described above.

When the lengths L1, L2 of one side portion 51V and the other portion 51H of the supporting members 42, 43 constituting the cross section approximately L-shaped, are set as L1>L2, an angle γ is preferably set larger than the above case of L1=L2 (see FIG. 31). The reason is the same as described above.

Hereupon, if the pressure is imposed on the object, the object is going to deform in the direction where the second momentum of the cross section becomes minimum. In the above conventional flame 16, as shown in FIG. 39, while one side portion (so-called vertical portion) 11V of the cross section approximately L-shaped supporting members 12, 13 is set almost vertical to the plane surface made of the four corners of the color selection mask 19, the other side portion (so-called horizontal portion) 11H is joined to the elasticity providing members 14, 15.

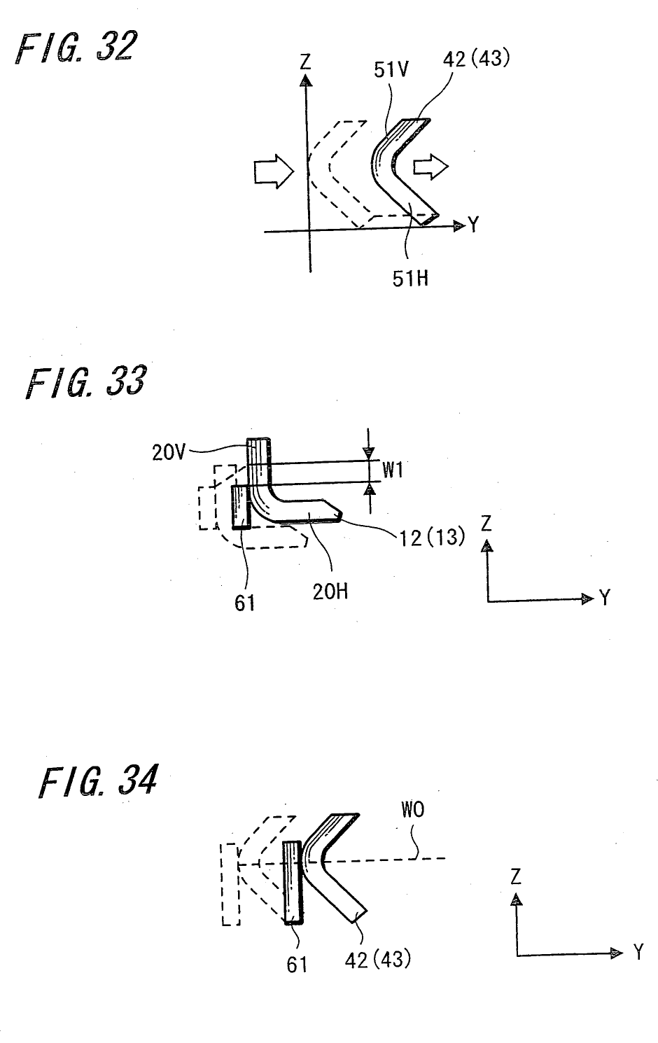

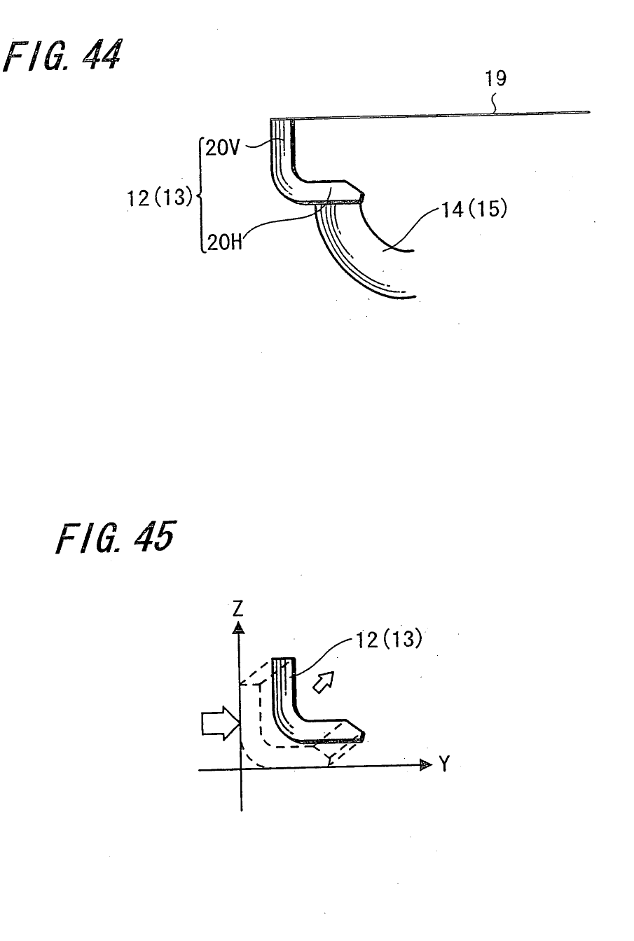

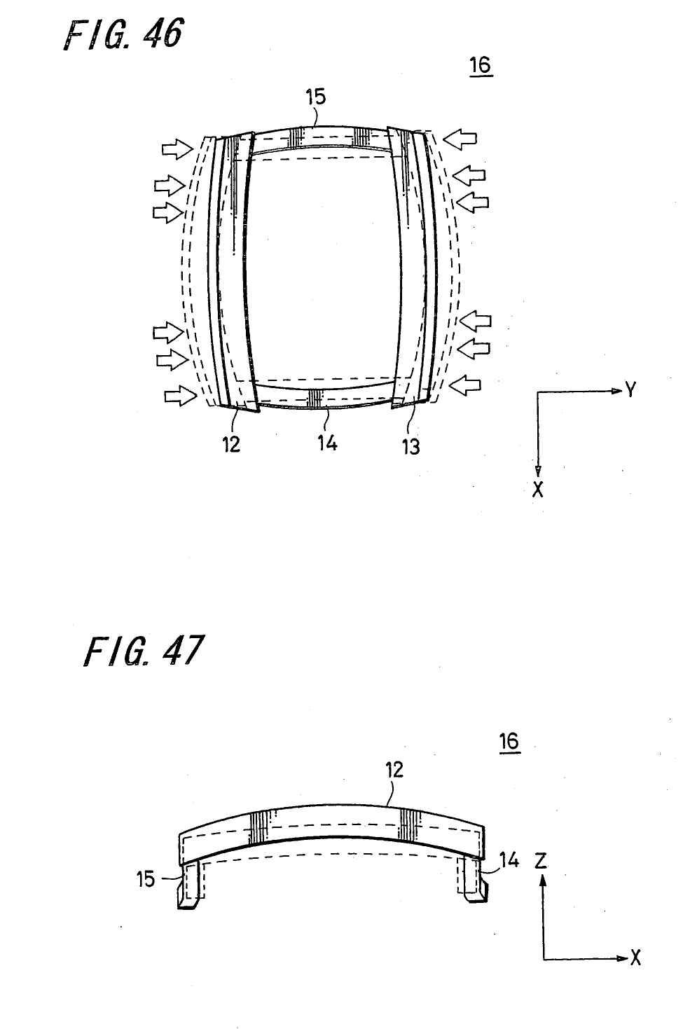

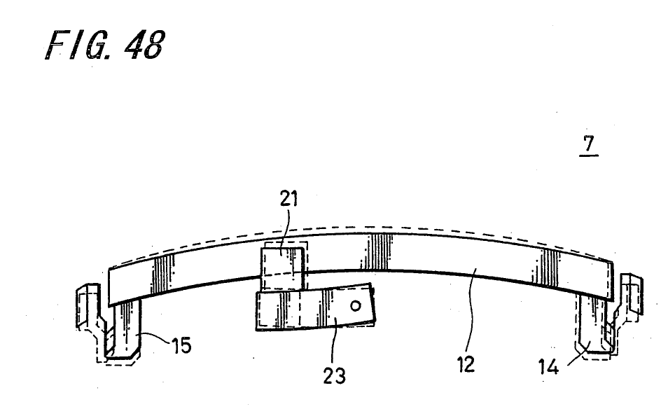

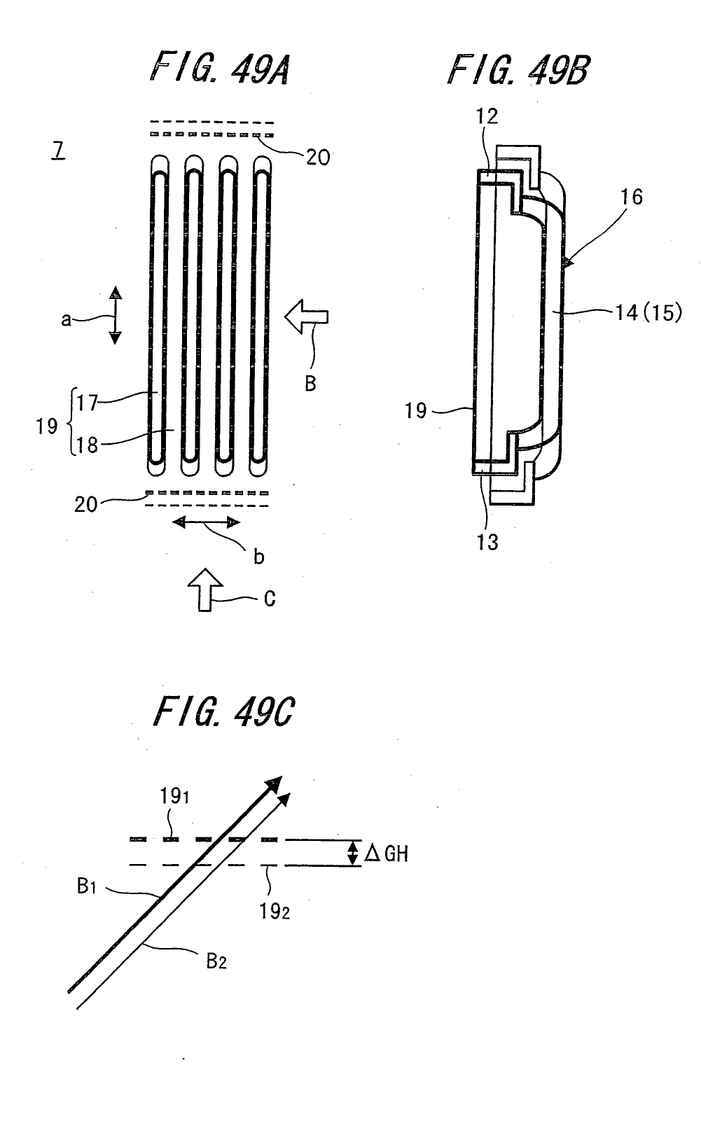

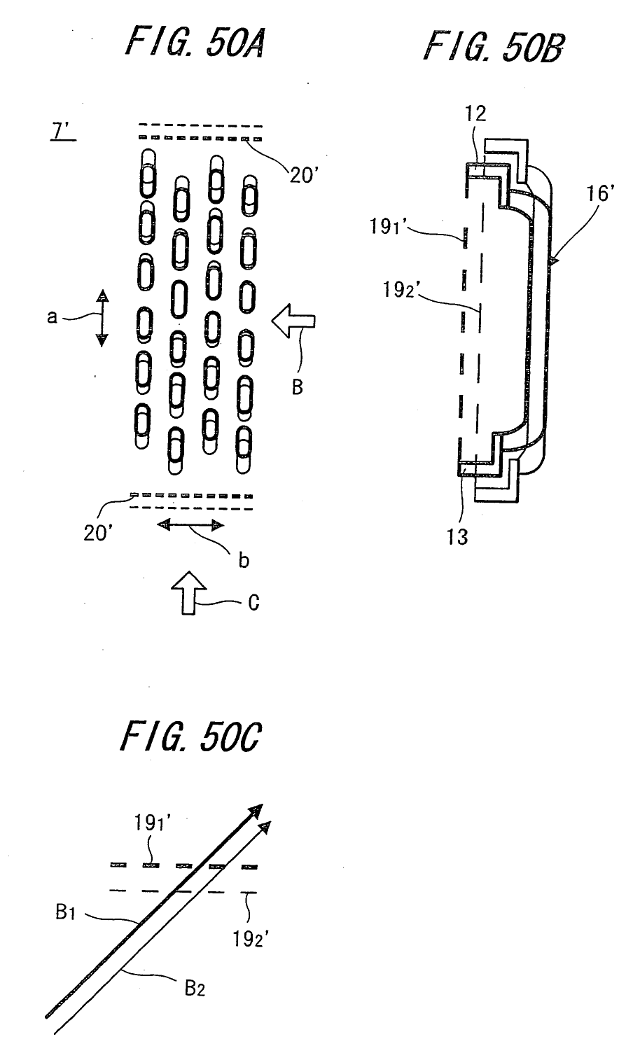

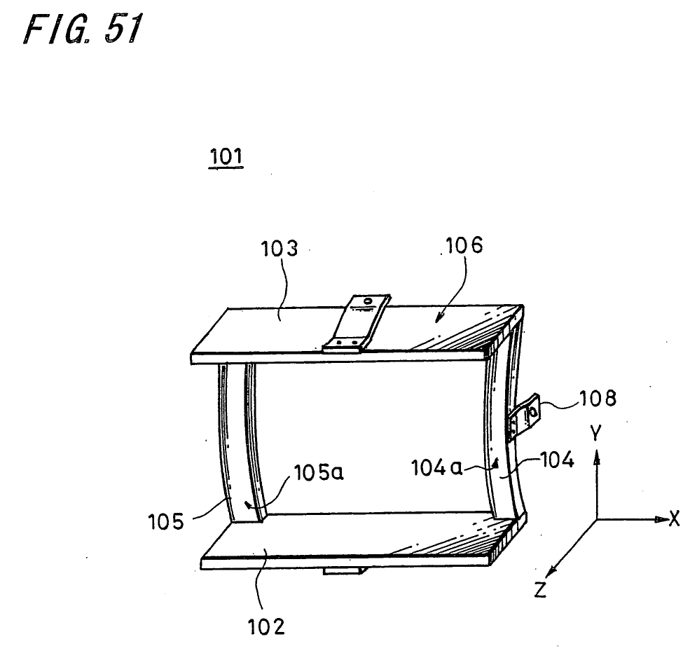

Hereupon, if the pressure is imposed on the object, the object is going to deform in the direction where the second momentum of the cross section becomes minimum. As shown in above FIG. 44, in the flame 16 in which one side portion 11V, to which a color selection mask 19 thereof is attached, of the cross section approximately L-shaped supporting members 12, 13 is disposed so as to be vertical to the surface of the color selection mask 19, as explained in FIG. 45, the supporting members 12, 13 are deformed in the Y direction (the opposing direction of both supporting members) and Z direction (the direction of the grill height GH). Compared with this, in case of this embodiment of the flame 46 in which the cross section approximately L-shaped supporting members 42, 43 are disposed at an appropriate inclined angle γ, as shown in FIG. 32, when the supporting members 42, 43 are pressurized in the Y direction, the members deforms only in the Y direction (the opposing direction of the supporting members), and do not deform in Z direction (the direction of the grill height GH). Further, with respect to the inclined angle γ, optimum values exist depending upon the shape of the cross section of the supporting members 42, 43, namely, a proportion between lengthwise and crosswise of approximately L-shaped cross section, the torsional rigidity of the supporting members 42, 43, and others.

Therefore, in the color selection mechanism 374 of this embodiment, at the time of assembling, whatever value is the amount of the change of the flame 46 in the Y direction of the flame 46, it does not change in the Z direction (direction of the grill height GH) at all points. Accordingly, when the color selection mask is thermally expanded on the operation of the cathode-ray tube, the grill height GH does not change at all points. Consequently, the shift of color may not be caused by the thermal expansion of the color selection mask 49.

With the color selection mechanism 374, so as to be supported by a panel pin (not shown) that is fixed at the inner surface of the panel 32 at a plurality of points, for example, at four points, on the supporting members 42, 43 and the elasticity providing members 44, 45 constituting four sides of a flame the supporting means composed of a spring holder 55 that is welded thereto, respectively and a support spring 57 that is welded to each spring holder 55 and having a pin engagement hole 56 at end portion. In the case where the color selection mechanism is supported at three points, the supporting means are, for example, attached to one supporting members 42 and the pair of elasticity providing members 44, 45. A dumper sensor for preventing the vibration is provided with tension on the color selection mask 49 as contacted therewith. With respect to the spring holder 55 that is welded to the supporting members 42, 43, one end thereof is bent so as to come along with the outer surface having an elbow shape, the bent surface is welded along the outer surface of the supporting members 42, 43, and the support spring 57 is welded to the other end that extends vertically (see FIG. 2).

According to the color selection mechanism 374 of this embodiment, the change of the grill height GH caused by the thermal expansion of the color selection mask 49 can perfectly be suppressed compared to the conventional color selection mechanism, the load to the support spring is reduced and the stable spring function can be obtained.

Conventionally, in an apparatus that imposes the turnbuckle on the flame before color selection mask is provided with tension, namely, in the apparatus that gives pressure to deform the color selection mechanism, as shown in FIG. 33, in case of the conventional flame 16, a pressurizing element 61 is provided contacting with the outer surface of the one side portion (vertical portion) 20V of the cross section approximately L-shaped supporting members 12, 13 of the flame and then pressure is given. At that time, as shown in the broken line and solid line, the position of the supporting members 12, 13 is shifted in the Z direction (grill height GH direction) as well as in the Y direction, and accordingly the contact position of the pressurizing element 61 for the supporting members 12, 13 is shifted. W1 is an amount of the shift of the contact position before and after pressurizing. The frictional condition of the contact portion varies depending upon various causes, for example, a condition of shot blast, a condition of cleaning of the flame, temperature of the flame and pressurizing element, and others, so that if the contact position is shifted, the pressurizing condition also becomes unstable. The fact becomes the critical cause of occurrence of the winkles on the color selection mask, and the dispersion of the distribution of the tension.

On the other hand, in the color selection mechanism 49 of this embodiment, as shown in FIG. 34, when the flame 46 is pressurized to deform, the pressurizing element 61 is provided contacting with the outside surface of the elbow shaped supporting members 12, 13 and pressure is given in the Y direction. At this time, as shown in the broken line and dashed line, after the pressure is imposed, the flame is not shifted in the Z direction (grill height GH direction), so that the same point is pressurized without change. Specifically, the contact position W0 is not shifted before and after the pressurization. Accordingly, the assembling of the color selection mechanism 49 can be performed with stable conditions.

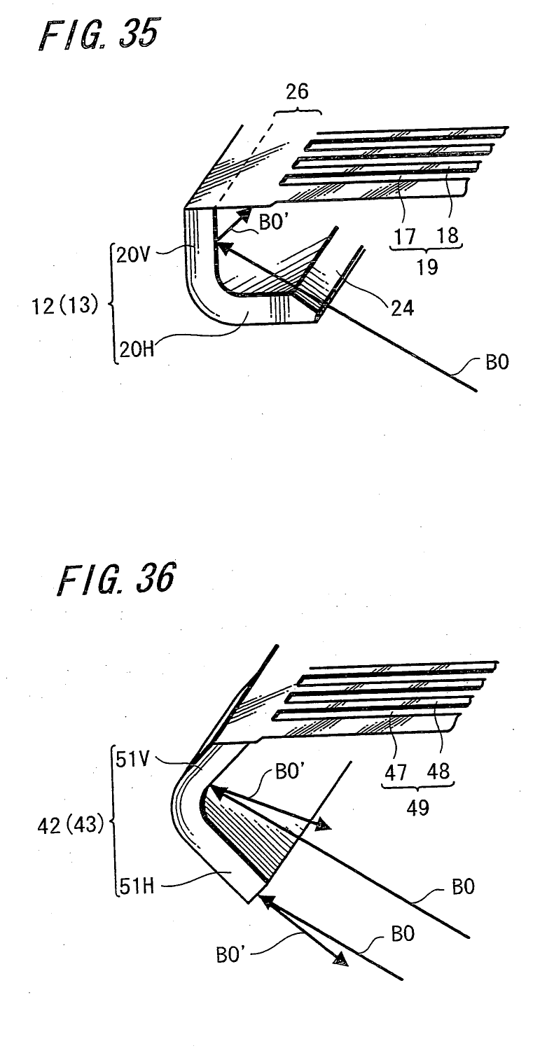

Then, in the conventional color selection mechanism 7, on the operation of the cathode-ray tube, so as not to display the reflection B0′ of the electron beam that is incident on the supporting members 12, 13 and the shadow caused by shielding the electron beam B0, as shown in FIG. 35, a shield portion 26 against the electron beam is provided on the outside of beam apertures 17 of the color selection mask 19, and an inclined portion 24 is provided at the end of the supporting members 12, 13, namely the end of the other side portion (horizontal portion) 20H. A wrinkle on the color selection mask 19 is generated at the shield portion 26, so that it is preferable that the shield portion 26 is as small as possible. The inclined portion 24 of the supporting members 12, 13 does not have any second effects; however, processing such as the cutting, pressing or the like is required to produce the portion.

On the other hand, in the color selection mechanism 374 of this embodiment, as shown in FIG. 36, the shield portion such as conventional ones is not quite provided on the outside of the beam aperture 47 of the color selection mask 49, also, the inclined portion or the like such as chamfering is not provided at the end of the other side portion of the cross section approximately L-shaped supporting members 42, 43. In this color selection mechanism 374, when the tilt of the supporting members 42, 43 with approximately L-shaped cross section is appropriately set with respect to the incident of the electron beam B0, the electron beam B0 does not reflect in the direction of the screen, namely the electron beam B0′ reflected from the supporting members 42, 43 is reflected in the reverse direction, and does not generate the shadow thereof. Therefore, processing such as the cutting or pressing for the chamfering is not required, and the color selection mechanism in high quality can be manufactured at lower costs compared to the conventional ones.

According to the flame 46 for use in the color selection mechanism of this embodiment, since the supporting members 42, 43 with approximately L-shaped cross section are each disposed in the shape of an elbow and joined to the elasticity providing members 44, 45, the supporting members 42, 43 are deformed only in the pressurized direction, and do not change in the grill height direction, when the flame 46 is pressurized and deformed for providing the color selection mask with tension. Therefore, when the color selection mask 49 is provided with tension to construct the color selection mechanism, even if the color selection mask 49 is affected by heat, the change of the grill height GH can be suppressed.

According to the color selection mechanism 374 of this embodiment, since the above flame 46 is included, if the color selection mask is expanded by heat, the surface of the supporting members 42, 43 where the color selection mask is attached is not shifted to the grill height GH direction. Therefore, the change of the grill height GH between the color selection mask 49 and the panel can be suppressed.

According to the color cathode-ray tube 31 of this embodiment, since the above color selection mechanism 374 is included, if the color selection mask 39 is thermally expanded on the operation, the change of the grill height GH can be suppressed, and the shift of color does not occur. Therefore, the temperature drift can be improved and high intensity and high definition can be obtained.

The color selection mechanism 37 of the color cathode-ray tube 31 according to the present invention can be composed of the flame that is formed by combining the supporting members 42, 43 with approximately L-shaped cross section and inclined as an elbow shape (see FIG. 27, or FIG. 29 through FIG. 31) and the elasticity providing members 44, 45 formed of the flat plate as shown in above FIGS. 2, 6, 8, 9A through 9C, 10 or FIG. 14. In the color selection mechanism with this construction the change of the grill height GH can be suppressed and the temperature drift can be improved, when the thermal effect is further imposed.

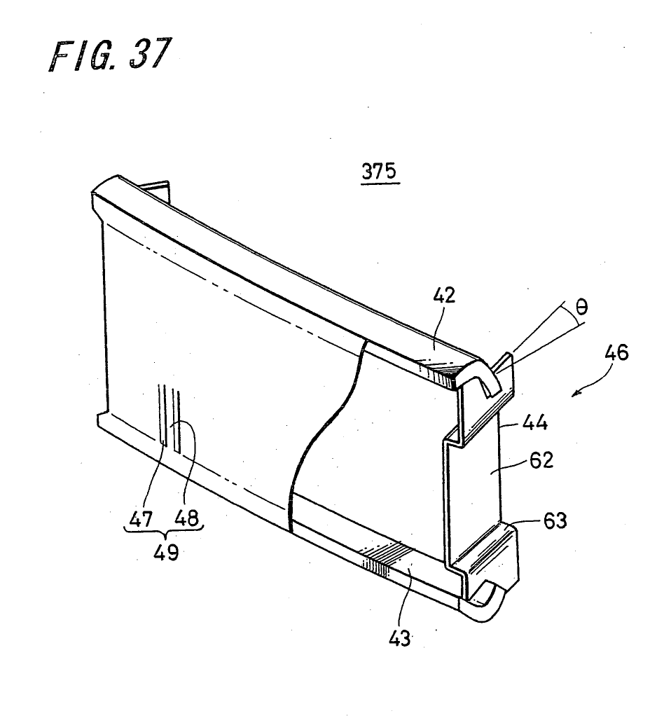

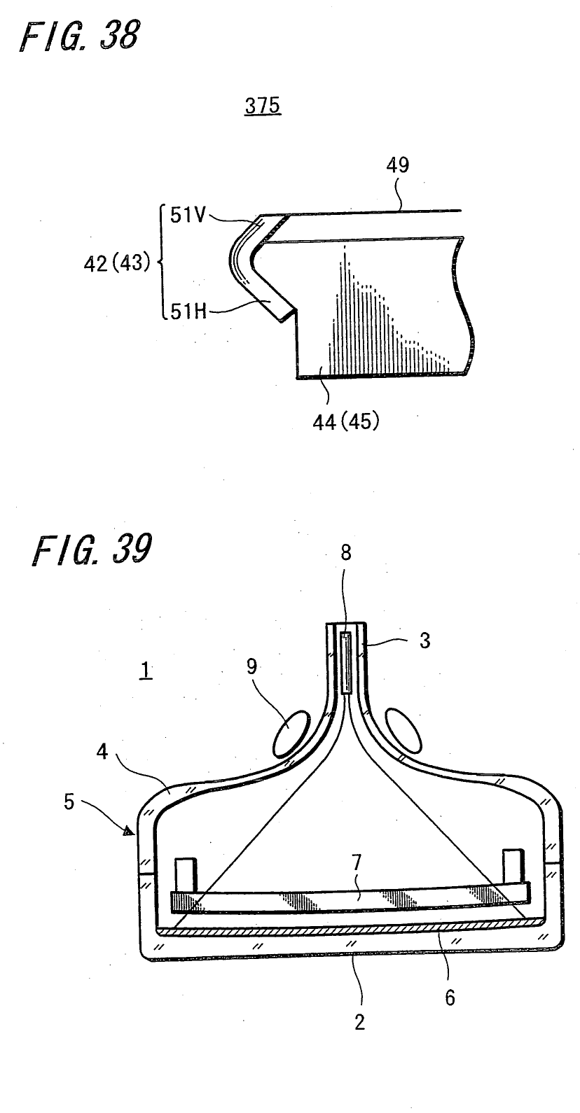

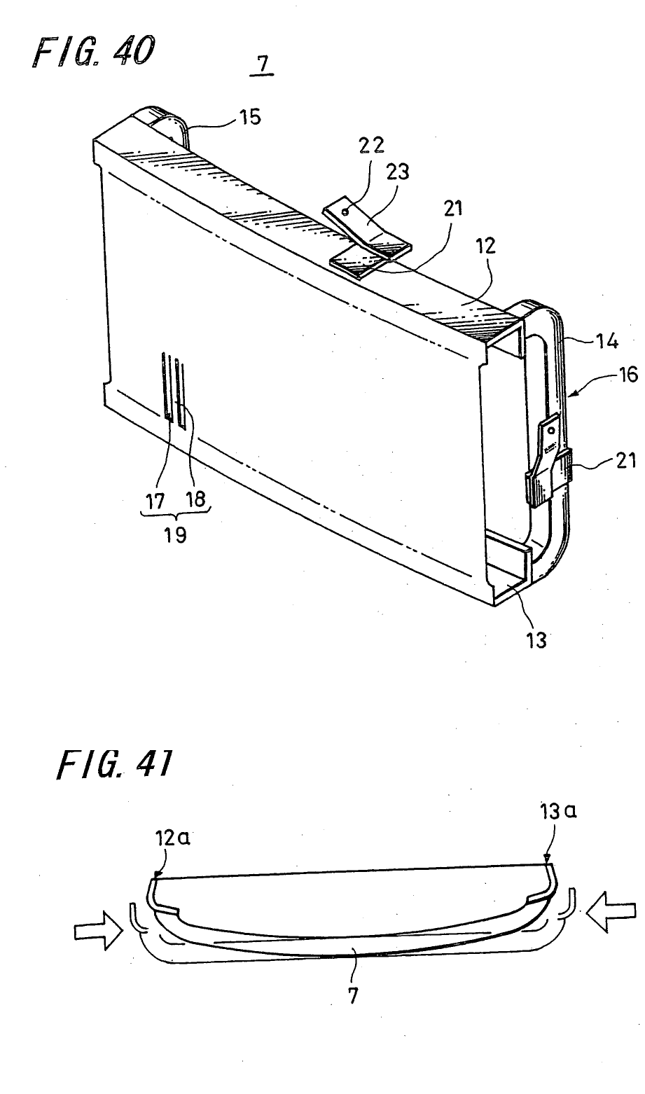

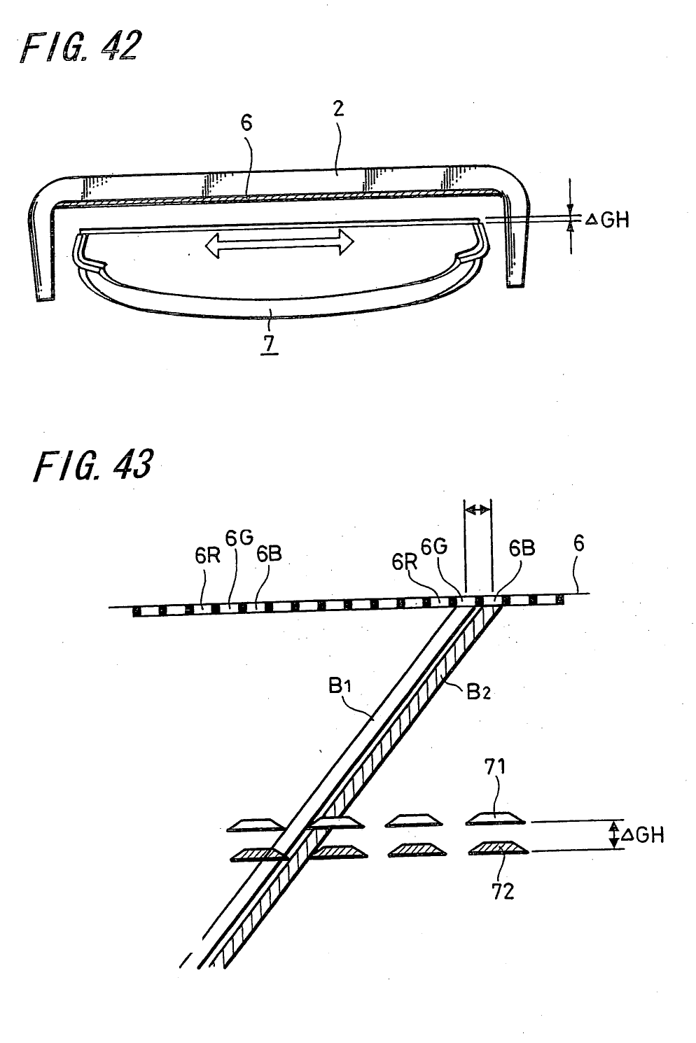

FIGS. 37 and 38 show further another embodiment of the color selection mechanism according to the present invention employing such flame. This embodiment is the color selection mechanism suitable for use in the further high definition cathode-ray tube.

In the color selection mechanism 375 according to this embodiment, a pair of cross section approximately L-shaped supporting members 42, 43 constituting the flame are disposed in an elbow shape, the same as the above, and a pair of elasticity providing members 44, 45 are formed by the flat plate 62 having the stepped portion 61 in the plate thickness direction and are inclined at a requiring angle θ between the plate surface 62 and a normal of the center of the color selection mask 49 and then attached to the supporting members 42, 43; and the flame 46 is formed. An angle θ of the elasticity providing members 44, 45 side can be selected in the range of 0°<θ<90° as mentioned before. Preferably, the angle can be selected in the range of 0°<θ<60° in order to obtain the strength of the elasticity providing members. Further preferably, the angle can be selected in the range of 0°<θ<45° so as not to disturb the incident of electron beams. Furthermore preferably, the angle can be selected in the range of 10°<θ<45° for easily controlling the change of the grill height GH direction.

With respect to the joint of the supporting members 42, 43 disposed in an elbow shape and the elasticity providing members 44, 45 made of the flat plate constituting this flame 46, each method for the joining shown in the above FIGS. 15 through 17, FIGS. 19 through 21, FIGS. 23 through 25, furthermore FIGS. 5A through 5B can be employed. As described above, while the pair of supporting members 42, 43 are pressurized and deformed in the Y direction, this color selection mask 49 is welded between the supporting members 42, 43, and then the pressure is released after welding to provide the mask with tension.

According to the color selection mechanism 372 including the flame 46 in which the elasticity providing members 44, 45 of the flat plate 62 are inclined and joined to the supporting members 42, 43, when the color selection mask 49 is thermally expanded, the tension of the elasticity providing members 44, 45 of the flame 46 is released; however, since the spring holder 55 of the elasticity providing members 44, 45 is attached to the position where the amount of the deformation of the elasticity providing members 45, 45 is zero, the position of the color selection mask 49 in the tube axis direction is not shifted, and the amount of the change of the grill height GH can be zero.

According to the color selection mechanism 375 of this embodiment, by employing the flame 36 composed by combining the supporting members 42, 43 having approximately L-shaped cross section disposed with inclination in an elbow shape and the elasticity providing members made of the flat plate 62 having the stepped portion 63 and disposed with inclination, effectiveness provided by each structure of the supporting members 42, 43 and the elasticity providing members 44, 45 works to suppress the change of the grill height, the change of the grill height GH is further suppressed at the time of the thermal expansion. Therefore, in the color cathode-ray tube 31 having this color selection mechanism 372, the temperature drift can be further improved and high intensity and high definition can be obtained.

Further, the elasticity providing members 44, 45 can be formed of the flat plate 62 without the stepped portion 63. This flat plate 62 can be attached to the supporting members 42, 43 at the above requiring angle θ, or can be attached at 0=0°. In this case, in comparison with the elasticity providing members made of a U-shaped square parts, the change of the grill height can also be unlimitedly small.

The color selection mechanism 374, 375 according to the above mentioned embodiments can be applied to the color cathode-ray tube 71 having multiple electron guns, as shown in the above FIG. 13.

In the above embodiment, the color selection mechanism of the present invention is applied to the aperture grill; however, the mechanism can be applied to the shadow mask (slot mask).

1. (Deleted)

2. (Deleted)

3. (Deleted)

4. A cathode-ray tube comprising a color selection mechanism, wherein a flame is formed of a pair of supporting members only extending in one direction and a pair of elasticity providing members, a color selection mask is provided with tension between said pair of supporting members, and said elasticity providing members is formed of a flat plate having a stepped portion in the plate thickness direction and is provided such that a surface of the plate is opposed to each other.

5. A cathode-ray tube according to claim 4, wherein said stepped portion is symmetrically provided for said pair of elasticity providing members, respectively.

6. A cathode-ray tube according to claim 4, wherein said stepped portion of said pair of elasticity providing members is formed of a bending portion that projects into the side of said pair of elasticity providing members opposing each other or projects into the reverse side thereto, setting the portion closest to the end as the standard position on the plane surface of the elasticity providing members.

7. A cathode-ray tube according to claim 5, wherein said stepped portion of said pair of elasticity providing members is formed of a bending portion that projects into the side of said pair of elasticity providing members opposing each other or projects into the reverse side thereto, setting the portion closest to the end as the standard position on the plane surface of the elasticity providing members.

8. A cathode-ray tube according to claim 4, wherein said stepped portion of said pair of elasticity providing members is formed of bending portions that project into both the side of said pair of elasticity providing members opposing each other and the reverse side thereto, setting the portion closest to the end as the standard position on the plane surface of the elasticity providing members.

9. A cathode-ray tube according to claim 5, wherein said stepped portion of said pair of elasticity providing members is formed of bending portions that project into both the side of said pair of elasticity providing members opposing to each other and the reverse side thereto, setting the portion closest to the end as the standard position on the plane surface of the elasticity providing members.

10. (Deleted)

11. (Deleted)

12. (Deleted)

13. A cathode-ray tube according to claim 4, wherein said elasticity providing member is attached to said supporting member such that an angle θ formed between the plate surface of the flat plate and a normal of the center of the said color selection mask satisfies 0°<θ<90°.

14. A cathode-ray tube according to claim 5, wherein said elasticity providing member is attached to said supporting member such that an angle θ formed between the plate surface of the flat plate and a normal of the center of the said color selection mask satisfies 0°<θ<90°.

15. A cathode-ray tube according to claim 6, wherein said elasticity providing member is attached to said supporting member such that an angle θ formed between the plate surface of the flat plate and a normal of the center of the said color selection mask satisfies 0°<θ<90°.

16. A cathode-ray tube according to claim 7, wherein said elasticity providing member is attached to said supporting member such that an angle θ formed between the plate surface of the flat plate and a normal of the center of the said color selection mask satisfies 0°<θ<90°.

17. A cathode-ray tube according to claim 8, wherein said elasticity providing member is attached to said supporting member such that an angle θ formed between the plate surface of the flat plate and a normal of the center of the said color selection mask satisfies 0°<θ<90°.

18. A cathode-ray tube according to claim 9, wherein said elasticity providing member is attached to said supporting member such that an angle θ formed between the plate surface of the flat plate and a normal of the center of the said color selection mask satisfies 0°<θ<90°.

19. (Deleted)

20. A cathode-ray tube according to claim 4, wherein said elasticity providing member is attached to said supporting member such that an angle θ formed between the plate surface of the flat plate and a normal of the center of the said color selection mask satisfies 10°<θ<45°.

21. A cathode-ray tube according to claim 5, wherein said elasticity providing member is attached to said supporting member such that an angle θ formed between the plate surface of the flat plate and a normal of the center of the said color selection mask satisfies 10°<θ<45°.

22. A cathode-ray tube according to claim 6, wherein said elasticity providing member is attached to said supporting member such that an angle θ formed between the plate surface of the flat plate and a normal of the center of the said color selection mask satisfies 10°<θ<45°.

23. A cathode-ray tube according to claim 7, wherein said elasticity providing member is attached to said supporting member such that an angle θ formed between the plate surface of the flat plate and a normal of the center of the said color selection mask satisfies 10°<θ<45°.

24. The cathode-ray tube according to claim 8, wherein said elasticity providing member is attached to said supporting member such that an angle θ formed between the plate surface of the flat plate and a normal of the center of the said color selection mask satisfies 10°<θ<45°.

25. A cathode-ray tube according to claim 9, wherein said elasticity providing member is attached to said supporting member such that an angle θ formed between the plate surface of the flat plate and a normal of the center of the said color selection mask satisfies 10°<θ<45°.

26. A cathode-ray tube comprising a color selection mechanism in which a flame is formed of a pair of supporting members and a pair of elasticity providing members, a color selection mask is provided with tension between said pair of supporting members, and the elasticity providing member is made of a flat plate and the plate surface is inclined so as to intersect an normal of the center of said color selection mask, wherein a supporting means for a panel is attached to said elasticity providing member on the portion where the change of distance between a phosphor screen and the color selection mask at the thermal expansion of the color selection mask is minimum including zero.

27. A cathode-ray tube comprising a color selection mechanism in which on a flame formed of a pair of supporting members and a pair of elasticity providing members, where said supporting member with approximately L-shaped cross section is inclined and joined to said elasticity providing member in the direction of the change of grill height being reduced, a color section mask is provided with tension.

28. A cathode-ray tube according to claim 27, wherein, of two side portions constituting approximately L-shaped cross section of the supporting member of said flame, an angle γ formed between a tangent line of the side surface of one side portion to which the color selection mask is attached and the surface of said color selection mask is set to 0°<γ<90°.

29. A cathode-ray tube according to claim 27, wherein, of two side portions constituting approximately L-shaped cross section of the supporting member of said flame, the end portion of one side portion to which the color selection mask is not attached is not chamfered.

30. A cathode-ray tube comprising a color selection mechanism, in which a flame formed of a pair of supporting members and a pair of elasticity providing members is included, a color selection mask is provided with tension between said pair of supporting members, said elasticity providing member is made of material that is elastically deformed within a surface intersecting the surface including a normal of the center of said color selection mask, and said supporting member with approximately L-shaped cross section is inclined in the direction of the change of grill height being reduced to be joined to said elasticity providing member.

31. A cathode-ray tube comprising a color selection mechanism, in which a flame formed of a pair of supporting members and a pair of elasticity providing members is included, a color selection mask is provided with tension between said pair of supporting members, said elasticity providing member is made of a flat plate and disposed such that a surface of the plate is opposed to each other, and said supporting member with approximately L-shaped cross section is inclined in the direction of the change of grill height being reduced to be joined to said elasticity providing member.

32. A cathode-ray tube according to claim 31 wherein, an angle θ formed between the plate surface of the flat plate of said elasticity providing member and a normal of the center of said color selection mask is set to 0°<θ<90°, of two side portions constituting approximately L-shaped cross section of the supporting member, an angle γ formed between a tangent line of the side surface of one side portion to which the color selection mask is attached and the surface of said color selection mask is set to 0°<γ<90°.

33. A cathode-ray tube according to claim 31, wherein said pair of elasticity providing members is formed of a flat plate having a stepped portion in the plate thickness direction.

34. A cathode-ray tube according to claim 31, wherein a supporting means for a panel is attached to said elasticity providing member on the portion where the change of distance between a phosphor screen and the dolor selection mask at the thermal expansion of the color selection mask is minimum including zero.

35. A cathode-ray tube comprising a color selection mechanism, in which a flame formed of a pair of supporting members and a pair of elasticity providing members is included, a color selection mask is provided with tension between said pair of supporting members, said pair of supporting members is formed with approximately L-shaped cross section, said pair of elasticity providing members is made of a flat plate and disposed such that a surface of the plate is opposed to each other, a cut-off portion is provided at a portion of said supporting member to which said elasticity providing member is attached, a contact surface of said cut-off portion to which said elasticity providing member is attached has an angle corresponding to the attaching angle of the elasticity providing members to said supporting member, the plate surface of said elasticity providing member is brought in contact with the contact surface of the cut-off portion of said supporting member, and said supporting member and said elasticity providing member are joined.

36. A cathode-ray tube comprising a color selection mechanism, in which a flame formed of a pair of supporting members and a pair of elasticity providing members is included, a color selection mask is provided with tension between said pair of supporting members, said pair of supporting members is formed with approximately L-shaped cross section, said pair of elasticity providing members is made of a flat plate and disposed such that a surface of the plate is opposed to each other, a cut-off portion is provided at a portion of said elasticity providing member to which said supporting member is attached, a contact surface of said cut-off portion to which said supporting member is attached has an angle corresponding to the attaching angle of the elasticity providing member to said supporting member, the contact surface of the cut-off portion of said elasticity providing member is brought in contact with the surface of the cut-off portion of said supporting member, and said supporting member and said elasticity providing member are joined.

37. A cathode-ray tube comprising a color selection mechanism, in which a flame formed of a pair of supporting members and a pair of elasticity providing members is included, a color selection mask is provided with tension between said pair of supporting members, said pair of supporting members is formed with approximately L-shaped cross section, said pair of elasticity providing members is made of a flat plate and disposed such that a surface of the plate is opposed to each other, the end surface of said supporting member with approximately L-shaped cross section where said elasticity providing member is attached has an angle corresponding to the attaching angle of said elasticity providing member to said supporting member, the plate surface of said elasticity providing member is brought in contact with the whole end surface of said supporting members, and said supporting member and said elasticity providing member are joined.

38. A cathode-ray tube comprising a color selection mechanism, in which a flame formed of a pair of supporting members and a pair of elasticity providing members made of a flat plate provided such that a surface of the plate is opposed to each other is included, a color selection mask is provided with tension between said pair of supporting members, and one side portion and the other side portion constituting approximately L-shaped cross section of said supporting member and said elasticity providing member are joined.

39. A cathode-ray tube comprising a color selection mechanism, in which a flame formed of a pair of supporting members and a pair of elasticity providing members is included, a color selection mask is provided with tension between said pair of supporting members, said elasticity providing member is made of a flat plate and disposed such that a surface of the plate is opposed to each other, said supporting member with approximately L-shaped cross section is inclined in the direction of the change of grill height being reduced and disposed, a cut-off portion is provided at a portion of said supporting member to which said elasticity providing member is attached, a contact surface of said cut-off portion to which said elasticity providing member is attached has an angle corresponding to the attaching angle of the elasticity providing member to said supporting member, the plate surface of said elasticity providing member is brought in contact with the contact surface of said cut-off portion of said supporting member, and said supporting member and said elasticity providing member are joined.

40. A cathode-ray tube according to claim 39 wherein, an angle θ formed between the plate surface of the flat plate of said elasticity providing member and a normal of the center of said color selection mask is set to 0°<θ<90°, of two side portions constituting approximately L-shaped cross section of the supporting member, an angle γ formed between a tangent line of the side surface of one side portion to which the color selection mask is attached and the surface of said color selection mask is set to 0°<γ<90°.

41. A cathode-ray tube comprising a color selection mechanism, in which a flame formed of a pair of supporting members and a pair of elasticity providing members is included, a color selection mask is provided with tension between said pair of supporting members, said elasticity providing member is made of a flat plate and disposed such that a surface of the plate is opposed to each other, said supporting member with approximately L-shaped cross section is inclined in the direction of the change of grill height being reduced and disposed, a cut-off portion is provided at the portion of said elasticity providing member to which said supporting member is attached, a contact surface of said cut-off portion to which said supporting member is attached has an angle corresponding to the attaching angle of the elasticity providing member to said supporting member, the contact surface of said cut-off portion of said elasticity providing member is brought in contact with the surface of said supporting member, and said supporting member and said elasticity providing member are joined.

42. A cathode-ray tube according to claim 41 wherein, an angle θ formed between the plate surface of the flat plate of said elasticity providing member and a normal of the center of said color selection mask is set to 0°<θ<90°, of two side portions constituting approximately L-shaped cross section of the supporting member, an angle γ formed between a tangent line of the side surface of one side portion to which the color selection mask is attached and the surface of said color selection mask is set to 0°<γ<90°.

43. A cathode-ray tube comprising a color selection mechanism, in which a flame formed of a pair of supporting members and a pair of elasticity providing members is included, a color selection mask is provided with tension between said pair of supporting members, said elasticity providing member is made of a flat plate and disposed such that a surface of the plate is opposed to each other, said supporting member with approximately L-shaped cross section is inclined in the direction of the change of grill height being reduced and disposed, the end surface of said supporting member with approximately L-shaped cross section where said elasticity providing member is attached has an angle corresponding to the attaching angle of the elasticity providing member to said supporting member, the plate surface of said elasticity providing member is brought in contact with the whole end surface of said supporting members, and said supporting member and said elasticity providing member are joined.

44. A cathode-ray tube according to claim 43 wherein, an angle θ formed between the plate surface of the flat plate of said elasticity providing member and a normal of the center of said color selection mask is set to 0°<θ<90°, of two side portions constituting approximately L-shaped cross section of the supporting member, an angle γ formed between a tangent line of the side surface of one side portion to which the color selection mask is attached and the surface of said color selection mask is set to 0°<γ<90°.

45. A method for manufacturing a cathode-ray tube including a color selection mechanism having a flame formed of a pair of supporting members with approximately L-shaped cross section and a pair of elasticity providing members formed of the flat plate, and a color selection mask provided with tension between said pair of supporting members, comprising the steps of: forming a cut-off portion provided at a portion of said supporting member to which said elasticity providing member is attached and giving a contact surface of said cut-off portion to which said elasticity providing member is attached an angle corresponding to the attaching angle of said elasticity providing member to said supporting member; and forming the flame by bringing the plate surface of said elasticity providing member in contact with the contact surface of the cut-off portion of said supporting member to be joined.

46. A method for manufacturing a cathode-ray tube including a color selection mechanism having a flame formed of a pair of supporting members with approximately L-shaped cross section and a pair of elasticity providing members formed of the flat plate, and a color selection mask provided with tension between said pair of supporting members, comprising the steps of: forming a cut-off portion provided at a portion of said elasticity providing member to which said supporting member is attached and giving a contact surface of said cut-off portion to which said supporting member is attached an angle corresponding to the attaching angle of said elasticity providing member to said supporting member; and forming the flame by bringing said contact surface of the cut-off portion of said elasticity providing member in contact with said supporting member to be joined.

47. A method for manufacturing a cathode-ray tube including a color selection mechanism having a flame formed of a pair of supporting members with approximately L-shaped cross section and a pair of elasticity providing members formed of the flat plate, and a color selection mask provided with tension between said pair of supporting members, comprising the steps of: giving the end surface of said supporting member with approximately L-shaped cross section to which said elasticity providing member is attached an angle corresponding to the attaching angle of said elasticity providing member to said supporting member; and forming the flame by bringing the plate surface of said elasticity providing member in contact with the whole end surface of said supporting member to be joined.

48. A method for manufacturing a cathode-ray tube including a color selection mechanism having a flame formed of a pair of supporting members with approximately L-shaped cross section and a pair of elasticity providing members formed of the flat plate, and a color selection mask provided with tension between said pair of supporting members, comprising the steps of: forming an engagement groove on said elasticity providing member for engaging with one side portion constituting approximately L-shaped cross section of said supporting member; and forming said flame by engaging said one portion of said supporting member with said engagement groove to join said elasticity providing member and said supporting member.

49. (Deleted)

50. (Deleted)

51. (Deleted)

52. A color selection mechanism comprising: a flame formed of a pair of supporting members only extending in one direction and a pair of elasticity providing members, and a color selection mask provided with tension between said pair of supporting members, wherein said pair of elasticity providing members is formed of a flat plate having a stepped portion in the plate thickness direction and is provided such that a surface of the plate is opposed to each other.

53. A color selection mechanism according to claim 52, wherein said stepped portion is symmetrically provided for said pair of elasticity providing members, respectively.

54. A color selection mechanism according to claim 52, wherein said elasticity providing member is attached to said supporting member such that an angle θ formed between the surface in which said elasticity providing member is elastically deformed and a normal of the center of the said color selection mask satisfies 0°<θ<90°.

55. A color selection mechanism according to claim 52, wherein said elasticity providing member is attached to said supporting member such that an angle θ formed between the surface in which said elasticity providing member is elastically deformed and a normal of the center of the said color selection mask satisfies 10°<θ<45°.

56. A color selection mechanism, in which on a flame formed of a pair of supporting members and a pair of elasticity providing members, where said supporting member with approximately L-shaped cross section is inclined and joined to said elasticity providing member in the direction of the change of grill height being reduced, a color section mask is provided with tension.

57. A color selection mechanism according to claim 56, wherein, of two side portions constituting approximately L-shaped cross section of the supporting member of said flame, an angle γ between a tangent line of the side surface of one side portion to which the color selection mask is attached and the surface of said color selection mask is set to 0°<γ<90°.

58. A color selection mechanism comprising: a flame formed of a pair of supporting members and a pair of elasticity providing members, and a color selection mask provided with tension between said pair of supporting members, wherein said elasticity providing member is made of material that is elastically deformed within a surface intersecting the surface including an normal of the center of said color selection mask, and said supporting member with approximately L-shaped cross section is inclined in the direction of the change of grill height being reduced to be joined to said elasticity providing member.

59. A color selection mechanism comprising: a flame formed of a pair of supporting members and a pair of elasticity providing members, and a color selection mask provided with tension between said pair of supporting members, wherein said elasticity providing member is made of a flat plate and disposed such that a surface of the plate is opposed to each other, and said supporting member with approximately L-shaped cross section is inclined in the direction of the change of grill height being reduced to be joined to said elasticity providing member.

60. A color selection mechanism according to claim 59, wherein, an angle θ formed between the plate surface of the flat plate of said elasticity providing member and a normal of the center of said color selection mask is set to 0°<θ<90°, of two side portions constituting approximately L-shaped cross section of the supporting member, an angle γ formed between a tangent line of the side surface of one side portion to which the color selection mask is attached and the surface of said color selection mask is set to 0°<γ<90°.

61. A flame for a color selection mechanism comprising a pair of supporting members and a pair of elasticity providing members, wherein said supporting member with approximately L-shaped cross section is inclined in the direction of the change of grill height being reduced and joined to said elasticity providing member.

62. A flame for a color selection mechanism according to claim 61, wherein of two side portions constituting the approximately L-shaped cross section of said supporting members, an angle γ formed between a tangent line of the side surface of one side portion to which a color selection mask is attached and the surface of said color selection mask is set to 0°<γ<90°.
